(19) United States
(12) Patent Application Publication
(10) Pub. No.: US 2025/0340373 A1
(43) Pub. Date: Nov. 6, 2025

(54) Automated Storage and Retrieval System

(71) Applicant: Signode Industrial Group LLC, Tampa, FL (US)

(72) Inventors: Roger Peniche, Chicago, IL (US); Kevin Cukierski, Elmhurst, IL (US)

(21) Appl. No.: 18/868,731

(22) PCT Filed: May 24, 2023
(86) PCT No.: PCT/US2023/023422

§ 371 Date: Nov. 22, 2024

Related U.S. Application Data
(60) Provisional application No. 63/346,071, filed on May 26, 2022.

(51) Int. Cl. B65G 1/04; B65G 1/06

(52) U.S. Cl. CPC B65G 1/0471; B65G 1/065

(57) ABSTRACT

Various embodiments of the present disclosure provide an automated storage and retrieval system including multiple containers (200), a storage rack having multiple container supports (151) for supporting the containers (200), multiple container-transport vehicles (300), and a control system. Generally, in operation, the control system controls the vehicles (300) to load containers (200) into and unload containers (200) from the storage rack from below.

### PRIORITY

This application claims priority to and the benefit of U.S. Provisional Application No. 63/346,071, filed May 26, 2022, the entire contents of which is incorporated herein by reference.

### FIELD

The present disclosure relates to automated storage and retrieval systems that use automated vehicles to store containers filled with items on a rack and, afterwards, to retrieve the containers.

### BACKGROUND

Warehousing and distribution facilities have grown in importance. These facilities receive many types of goods and store them until a later time at which the goods are shipped elsewhere, such as to consumers' homes or to retail stores. Some of these facilities store hundreds, thousands, or even tens of thousands of unique goods (e.g., unique stock keeping units) in different configurations, such as on pallets or in smaller bins. These pallets and/or bins are typically stored on storage racks to maximize the use of vertical space. To increase efficiency, many of these facilities have installed one of many types of automated storage and retrieval systems that use warehouse-management software to keep track of the goods and their locations and that use automated vehicles to store the pallets and bins in and retrieve the pallets and bins from the storage racks.

### SUMMARY

Various embodiments of the present disclosure provide an automated storage and retrieval system including a storage rack, multiple containers, multiple container-transport vehicles, and a control system. Generally, in operation, the control system controls the vehicles to load containers into and unload containers from the storage rack from below.

### BRIEF DESCRIPTION OF THE FIGURES

FIG. 1A is a perspective view of one example embodiment of an automated storage and retrieval system of the present disclosure including a storage rack, multiple containers, and a container-transport vehicle.

FIG. 1B is a block diagram of the AS/RS control system and the vehicles of the automated storage and retrieval system of FIG. 1A.

FIG. 2 is a perspective view of the storage rack of the automated storage and retrieval system of FIG. 1.

FIG. 3 is a perspective view of part of the storage rack of FIG. 2.

FIG. 4 is a top plan view of the storage rack of FIG. 2.

FIG. 5 is a top plan view similar to FIG. 4, but with a container stored in each container-storage area of the storage rack.

FIG. 6 is a front elevational view of the storage rack corresponding to FIG. 5.

FIG. 7A is a top perspective view of a container of the automated storage and retrieval system of FIG. 1.

FIG. 7B is a bottom perspective view of the container of FIG. 7A

FIG. 7C is a side elevational view of the container of FIG. 7A.

FIGS. 7D is a front elevational view of the container of FIG. 7A.

FIG. 7E are cross-sectional front elevational views of the container of FIG. 7A being centered between two dividers of the storage rack.

FIG. 8A is a perspective view of the container-transport vehicle of the automated storage and retrieval system of FIG. 1.

FIG. 8B is a block diagram of showing certain components of the container-transport vehicle of FIG. 8A.

FIG. 9 is a flowchart showing a method of loading a container onto the storage rack and into an empty storage area of the storage rack.

FIGS. 10A-10D are side elevational views showing the container-transport vehicle loading a first container onto the storage rack in accordance with the method of FIG. 9.

FIG. 11 is a flowchart showing a method of loading a container onto the storage rack and into a storage area occupied by another container.

FIGS. 12A-12G are side elevational views showing the container-transport vehicle loading a second container onto the storage rack beneath the first container of FIGS. 10A-10D in accordance with the method of FIG. 11.

FIG. 13 is a flowchart showing a method of unloading a container from a storage rack when the container supports another container.

FIGS. 14A-14G are side elevational views showing the container-transport vehicle unloading the second container of FIGS. 12A-12G from beneath the first container of FIGS. 10A-10D and from the storage rack in accordance with the method of FIG. 13.

FIG. 15 is a flowchart showing a method of unloading a container from a storage rack when the container does not support any other containers.

FIGS. 16A-16D are side elevational views showing the container-transport vehicle unloading the first container of FIGS. 10A-10D from the storage rack.

FIGS. 17A-17C are side elevational views of a rack engager of another embodiment of a container as the container is being loaded onto the storage rack.

FIGS. 18A-18D are perspective, side elevational, top plan, and front elevational views of another embodiment of the container of the present disclosure.

FIG. 19 is a perspective view of the container of FIGS. 18A-18D and two dividers of another embodiment of the storage rack of the present disclosure.

FIG. 20 is a perspective view of an example multi-level automated storage and retrieval system of the present disclosure.

### DETAILED DESCRIPTION

While the systems, devices, and methods described herein may be embodied in various forms, the drawings show and the specification describes certain exemplary and non-limiting embodiments. Not all of the components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, connected, etc., are not intended to be limited to direct mounting methods but should be interpreted broadly to include indirect and operably mounted, connected, and like mounting methods. This specification is intended to be taken as a whole and interpreted in accordance with the principles of the present disclosure and as understood by one of ordinary skill in the art.

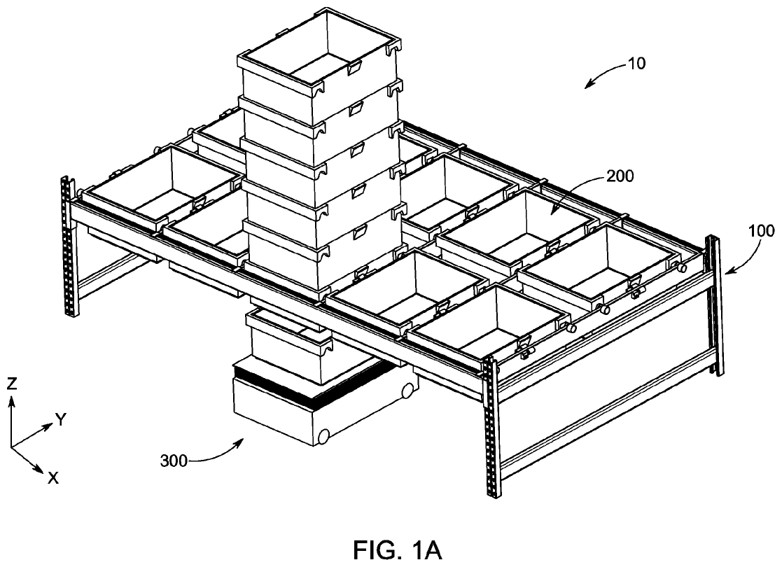

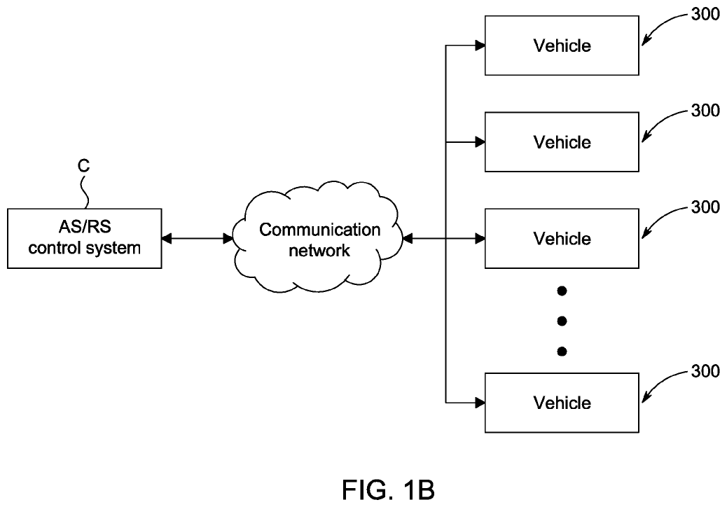

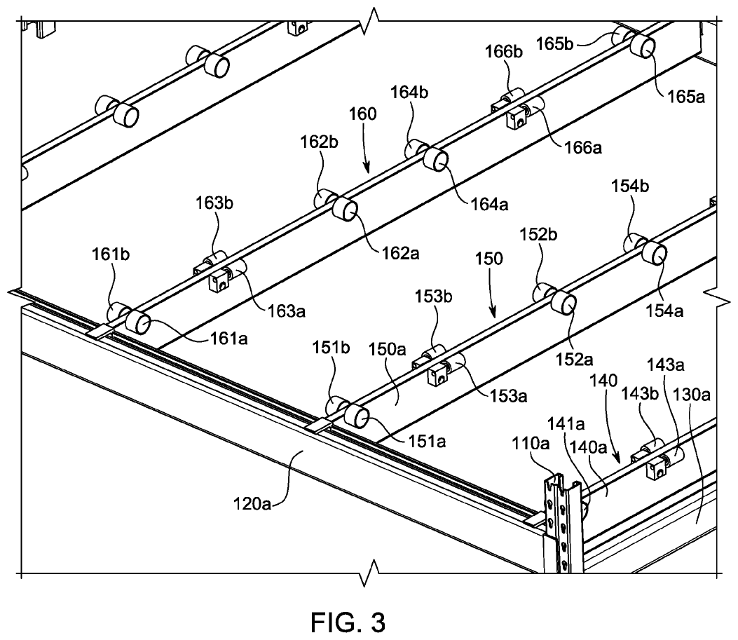

FIGS. 1A-8B show one embodiment of an automated storage and retrieval system 10 of the present disclosure (“AS/RS” for short). The AS/RS 10 includes a storage rack 100, multiple containers 200, multiple container-transport vehicles 300 (“vehicles” for short), and an AS/RS control system C. Generally, in operation, the AS/RS control system C communicates with the vehicles 300 over a communication network and controls the vehicles 300 to load containers 200 into and unload containers 200 from the storage rack 100 from below. A coordinate system shown in several of the drawings, including FIG. 1, is used herein as a frame of reference for orientation and directional movement of various components of the AS/RS 10 in the X-, Y-, and Z-directions (which are perpendicular to one another in this example embodiment).

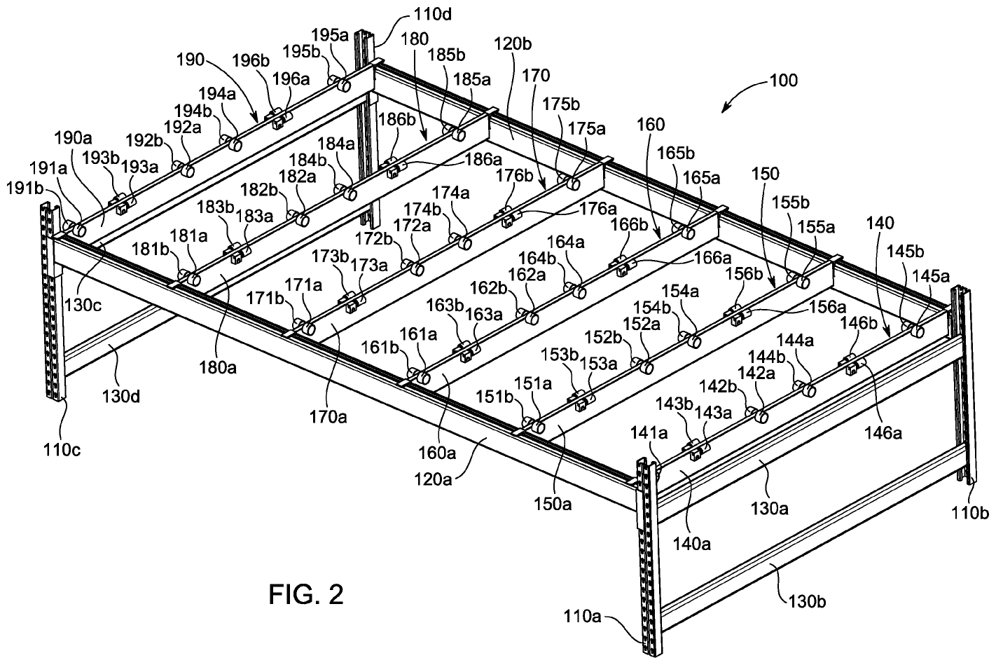

The storage rack 100, best shown in FIGS. 2-6, acts as a storage location for the containers 200. The storage rack 100 includes first, second, third, and fourth legs 110a, 110b, 110c, and 110d; front and back rails 120a and 120b; first, second, third, and fourth side rails 130a, 130b, 130c, and 130d; and first, second, third, fourth, fifth, and sixth dividers 140, 150, 160, 170, 180, and 190.

The first, second, third, and fourth legs 110a-110d are oriented generally upright in the Y-direction. The front rail 120a extends between the first and third legs 110a and 110c in the X-direction and connects them. The back rail 120b extends between the second and fourth legs 110b and 110d in the X-direction and connects them. The first and second side rails 130a and 130b are spaced-apart from one another in the Z-direction and extend between the first and second legs 110a and 110b in the Y-direction and connect them. The third and fourth side rails 130c and 130d are spaced-apart from one another in the Z-direction and extend between the third and fourth legs 110c and 110d in the Y-direction and connect them. The legs and rails are mechanically connected to one another in any suitable manner, such as (but not limited to) via fasteners or keyhole fittings. The legs and rails may be formed from any suitable material, such as steel or aluminum.

The first divider 140 includes a divider rail 140a; eight container supports 141a, 141b, 142a, 142b, 144a, 144b, 145a, and 145b supported by the divider rail 140a; and four container centerers 143a, 143b, 146a, and 146b supported by the divider rail 140a.

The container supports 141a, 142a, 144a, and 145a are connected to the divider rail 140a and extend transversely from one side of the divider rail 140a, and the container supports 141b, 142b, 144b, and 145b are connected to the divider rail 140a and extend transversely from the opposite side of the divider rail 140a. Here, the container supports include cylindrical rollers that are rotatably connected to (and rotatable relative to) the divider rail 140a. Specifically, in this example embodiment, the container supports 141a and 141b are connected to opposing ends of a first support axle (not shown) extending transversely through the divider rail 140a, the container supports 142a and 142b are connected to opposing ends of a second support axle (not shown) extending transversely through the divider rail 140a, the container supports 144a and 144b are connected to opposing ends of a third support axle (not shown) extending transversely through the divider rail 140a, and the container supports 145a and 145b are connected to opposing ends of a fourth support axle (not shown) extending transversely through the divider rail 140a. In other embodiments, the container supports may take any other suitable shape and/or be fixed relative to the divider rail.

The container centerer 143a is connected to the divider rail 140a and positioned between the container supports 141a and 142a. The container centerer 143b is connected to the divider rail 140a and positioned between the container supports 141b and 142b. The container centerer 146a is connected to the divider rail 140a and positioned between the container supports 144a and 145a. The container centerer 146b is connected to the divider rail 140a and positioned between the container supports 144b and 145b. Here, the container centerers include cylindrical rollers that are rotatably connected to (and rotatable relative to) the divider rail 140a. Specifically, in this example embodiment: the container centerer 143a is connected to a first mounting block (not labeled), which is connected to the divider rail 140a, via a first centerer axle (not shown) extending from the first mounting block generally parallel to the divider rail 140a; the container centerer 143b is connected to a second mounting block (not labeled), which is connected to the divider rail 140a, via a second centerer axle (not shown) extending from the second mounting block generally parallel to the divider rail 140a; the container centerer 146a is connected to a third mounting block (not labeled), which is connected to the divider rail 140a, via a third centerer axle (not shown) extending from the third mounting block generally parallel to the divider rail 140a; and the container centerer 146b is connected to a fourth mounting block (not labeled), which is connected to the divider rail 140a, via a fourth centerer axle (not shown) extending from the fourth mounting block generally parallel to the divider rail 140a. In other embodiments, the container centerers may take any other suitable shape and/or be fixed relative to the divider rail. In further embodiments, the dividers do not include any container centerers.

In this embodiment, the second, third, fourth, fifth, and sixth dividers 150, 160, 170, 180, and 190 include the same components arranged in the same configuration as the first divider 140. While these additional dividers are not separately described for brevity, the same element-numbering scheme is used in the Figures and the description below, with the middle numeral “4” being replaced by “5,” “6,” “7,” “8,” and “9” for the dividers 150, 160, 170, 180, and 190, respectively.

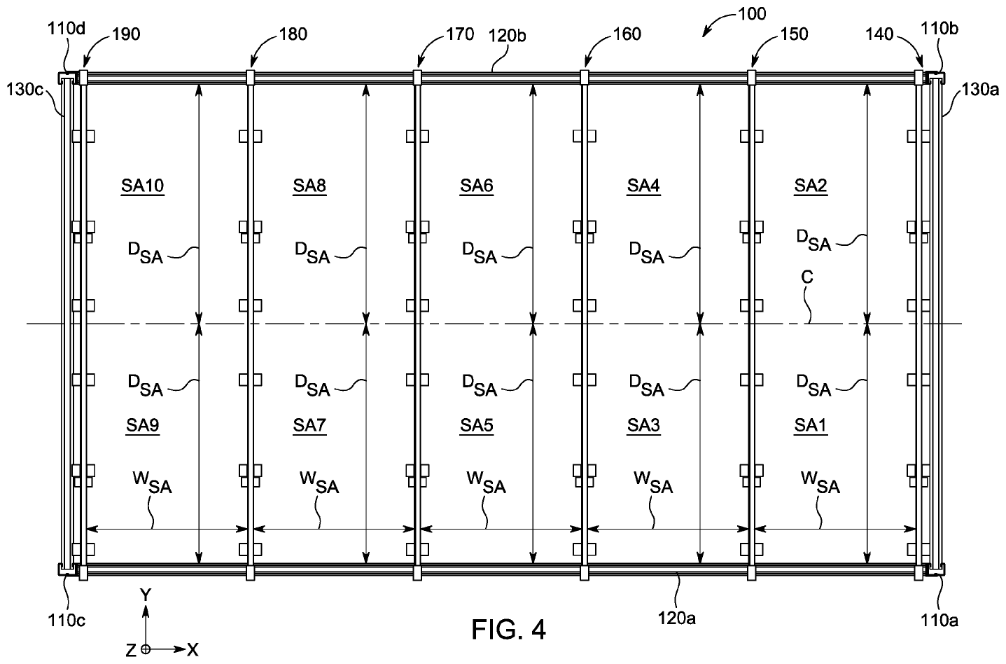

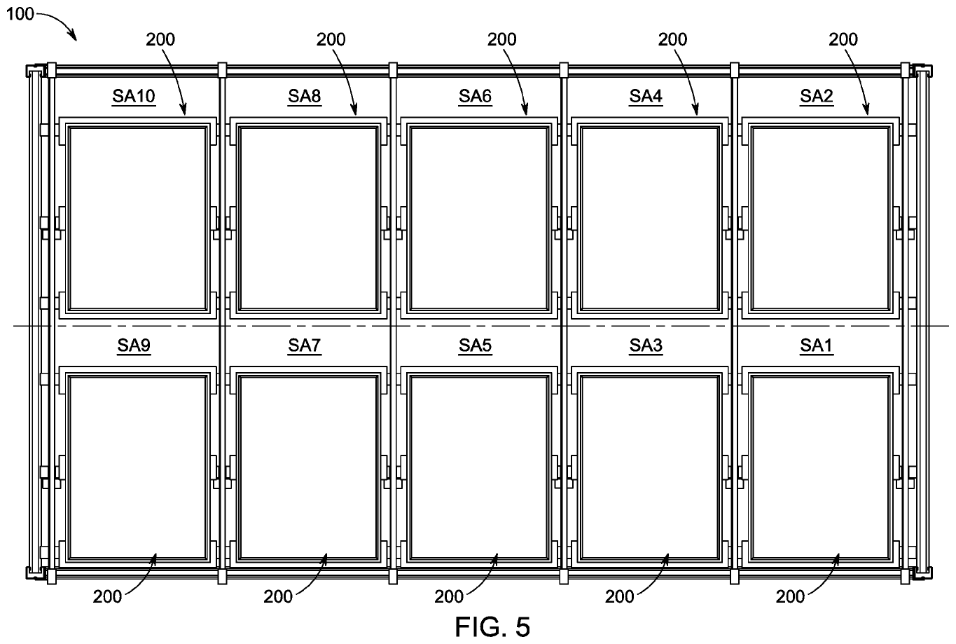

As best shown in FIGS. 4 and 5, the dividers 140, 150, 160, 170, 180, and 190 are positioned and oriented so their respective divider rails 140a, 150a, 160a, 170a, 180a, and 190a: (1) extend between the front and back rails 120a and 120b in the Y-direction and are generally parallel; (2) are spaced-apart a distance W_{SA} in the X-direction; and (3) are connected to the front and back rails 120a and 120b in any suitable manner. The front and back rails 120a and 120b and the dividers 140, 150, 160, 170, 180, and 190 form multiple container-storage areas SA1-SA10 (“storage areas” for brevity), each of which is sized and shaped to receive multiple containers 200 stacked atop one another.

First and second storage areas SA1 and SA2 are defined between the front and back rails 120a and 120b and the first and second dividers 140 and 150. Specifically, the first storage area SA1 is defined between the front rail 120a, the first and second dividers 140 and 150, and a centerline C extending in the X-direction about halfway between the front and back rails 120a and 120b. The second storage area SA2 is defined between the centerline C, the first and second dividers 140 and 150, and the back rail 120b.

Third and fourth storage areas SA3 and SA4 are defined between the front and back rails 120a and 120b and the second and third dividers 150 and 160. Specifically, the third storage area SA3 is defined between the front rail 120a, the second and third dividers 150 and 160, and the centerline C. The fourth storage area SA4 is defined between the centerline C, the second and third dividers 150 and 160, and the back rail 120b. The third and fourth storage areas SA3 and SA4 are the same size as the first and second storage areas SA1 and SA2.

Fifth and sixth storage areas SA5 and SA6 are defined between the front and back rails 120a and 120b and the third and fourth dividers 160 and 170. Specifically, the fifth storage area SA5 is defined between the front rail 120a, the third and fourth dividers 160 and 170, and the centerline C. The sixth storage area SA6 is defined between the centerline C, the third and fourth dividers 160 and 170, and the back rail 120b. The fifth and sixth storage areas SA5 and SA6 are the same size as the first and second storage areas SA1 and SA2.

Seventh and eighth storage areas SA7 and SA8 are defined between the front and back rails 120a and 120b and the fourth and fifth dividers 170 and 180. Specifically, the seventh storage area SA7 is defined between the front rail 120a, the fourth and fifth dividers 170 and 180, and the centerline C. The eighth storage area SA8 is defined between the centerline C, the fourth and fifth dividers 170 and 180, and the back rail 120b. The seventh and eighth storage areas SA7 and SA8 are the same size as the first and second storage areas SA1 and SA2.

Ninth and tenth storage areas SA9 and SA10 are defined between the front and back rails 120a and 120b and the fifth and sixth dividers 180 and 190. Specifically, the ninth storage area SA9 is defined between the front rail 120a, the fifth and sixth dividers 180 and 190, and the centerline C. The tenth storage area SA10 is defined between the centerline C, the fifth and sixth dividers 180 and 190, and the back rail 120b. The ninth and tenth storage areas SA8 and SA10 are the same size as the first and second storage areas SA1 and SA2.

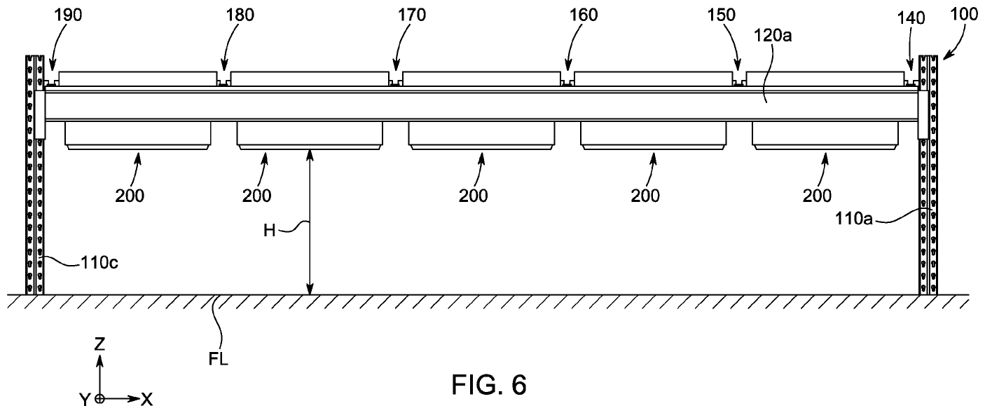

Each storage area SA has a width W_{SA} extending in the X-direction. The width W_{SA} that is greater than the width W_{C} of a container 200 (described below). In this particular example embodiment, this size differential enables a vehicle 300 to raise and lower a container in the Z-direction between two adjacent dividers when loading/unloading the container into/from a storage area SA without contacting the dividers, as described in detail below (though in other embodiments the container may contact part of the storage rack during raising/lowering). Additionally, each storage area SA has a depth D_{SA} extending in the Y-direction. The depth D_{SA} is greater than the depth Dc of a container 200 (described below). It is also large enough to enable a vehicle 300 to move a container in the Y-direction to clear the container supports when loading/unloading the container into/from a storage area SA without the container entering the adjacent storage area SA and contacting (and possibly dislodging) another container stored there, as described in detail below. As shown in FIG. 6, the front and back rails 120a and 120b are connected to the legs 110a-110d so the height H of the bottom of a container 200 above the floor FL in the Z-direction is greater than the height of the top of a container on the lifting platform of a vehicle 300 above the floor FL when the lifting platform is in its home (lower) position (described below). This enables the vehicle to travel beneath other storage areas SA while carrying a container without the container contacting (and possibly dislodging) other containers stored in the storage areas SA, as described in detail below.

In this example embodiment, the storage areas all have the same size (e.g., width and depth). In other embodiments, the storage rack may define storage areas having two or more different sizes. For instance, certain dividers may be spaced apart further than others, resulting in certain storage areas being wider than others. And/or certain container supports may be spaced apart further than others, resulting in certain storage areas being deeper than others. The dividers and container supports may be positioned relative to one another in any suitable manner to configure the storage rack to be used with any suitable quantity of differently sized containers.

Each storage area SA is associated with a set of the container supports used to support containers loaded into that storage area and a set of the container centerers used to center containers loaded into that storage area in the X-direction. For a given storage area, the set of container supports includes a pair of adjacent container supports from each divider bordering that particular storage area, and the set of container centerers includes the container centerers between the respective pairs of container supports.

The first storage area SA1 is associated with a first set of container supports and a first set of container centerers. The first set of container supports includes the container supports 141b and 142b of the first divider 140 and the container supports 151a and 152a of the second divider 150. The first set of container centerers includes the container centerer 143b of the first divider 140 and the container centerer 153a of the second divider 150. The second storage area SA2 is associated with a second set of container supports and a second set of container centerers. The second set of container supports includes the container supports 144b and 145b of the first divider 140 and the container supports 154a and 155a of the second divider 150. The second set of container centerers includes the container centerer 146b of the first divider 140 and the container centerer 156a of the second divider 150.

The third storage area SA3 is associated with a third set of container supports and a third set of container centerers. The third set of container supports includes the container supports 151b and 152b of the second divider 150 and the container supports 161a and 162a of the third divider 160. The third set of container centerers includes the container centerer 153b of the second divider 150 and the container centerer 163a of the third divider 160. The fourth storage area SA4 is associated with a fourth set of container supports and a fourth set of container centerers. The fourth set of container supports includes the container supports 154b and 155b of the second divider 150 and the container supports 164a and 165a of the third divider 160. The fourth set of container centerers includes the container centerer 156b of the second divider 150 and the container centerer 166a of the third divider 160.

The fifth storage area SA5 is associated with a fifth set of container supports and a fifth set of container centerers. The fifth set of container supports includes the container supports 161b and 162b of the third divider 160 and the container supports 171a and 172a of the fourth divider 170. The fifth set of container centerers includes the container centerer 163b of the third divider 160 and the container centerer 173a of the fourth divider 170. The sixth storage area SA6 is associated with a sixth set of container supports and a sixth set of container centerers. The sixth set of container supports includes the container supports 164b and 165b of the third divider 160 and the container supports 174a and 175a of the fourth divider 170. The sixth set of container centerers includes the container centerer 166b of the third divider 160 and the container centerer 176a of the fourth divider 170.

The seventh storage area SA7 is associated with a seventh set of container supports and a seventh set of container centerers. The seventh set of container supports includes the container supports 171b and 172b of the fourth divider 170 and the container supports 181a and 182a of the fifth divider 180. The seventh set of container centerers includes the container centerer 173b of the fourth divider 170 and the container centerer 183a of the fifth divider 180. The eighth storage area SA8 is associated with an eighth set of container supports and an eighth set of container centerers. The eighth set of container supports includes the container supports 174b and 175b of the fourth divider 170 and the container supports 184a and 185a of the fifth divider 180. The eighth set of container centerers includes the container centerer 176b of the fourth divider 170 and the container centerer 186a of the fifth divider 180.

The ninth storage area SA9 is associated with a ninth set of container supports and a ninth set of container centerers. The ninth set of container supports includes the container supports 181b and 182b of the fifth divider and the container supports 191a and 192a of the sixth divider 160. The ninth set of container centerers includes the container centerer 183b of the fifth divider 180 and the container centerer 193a of the sixth divider 190. The tenth storage area SA10 is associated with a tenth set of container supports and a tenth set of container centerers. The tenth set of container supports includes the container supports 184b and 185b of the fifth divider 180 and the container supports 194a and 195a of the sixth divider 190. The tenth set of container centerers includes the container centerer 186b of the fifth divider 180 and the container centerer 196a of the sixth divider 190.

The storage rack 100 is merely one example storage rack that may be employed with the AS/RS 10. Other storage racks may be configured differently, for instance with different quantities or types of legs, different quantities or types of rails, different quantities or types of dividers, different quantities or types of container supports and/or different quantities or types of container centerers. Storage racks may be sized and shaped for bespoke installations and may be configured to have any suitable quantity of storage areas.

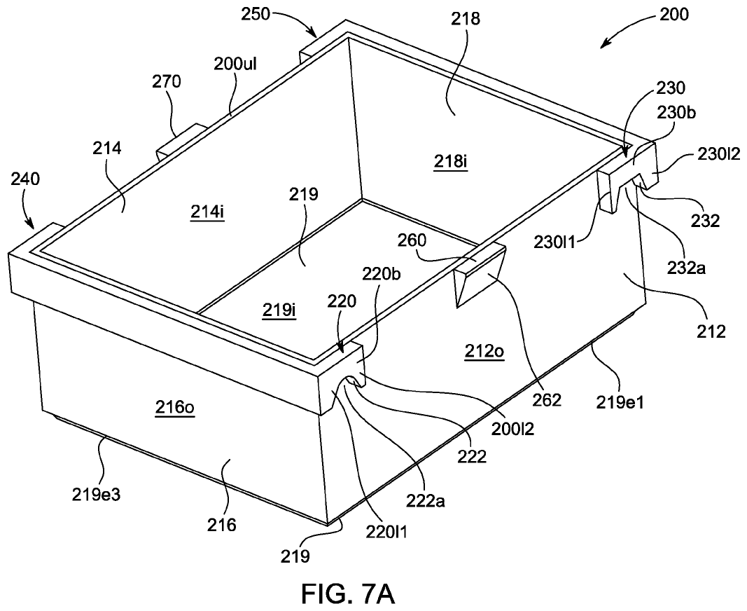

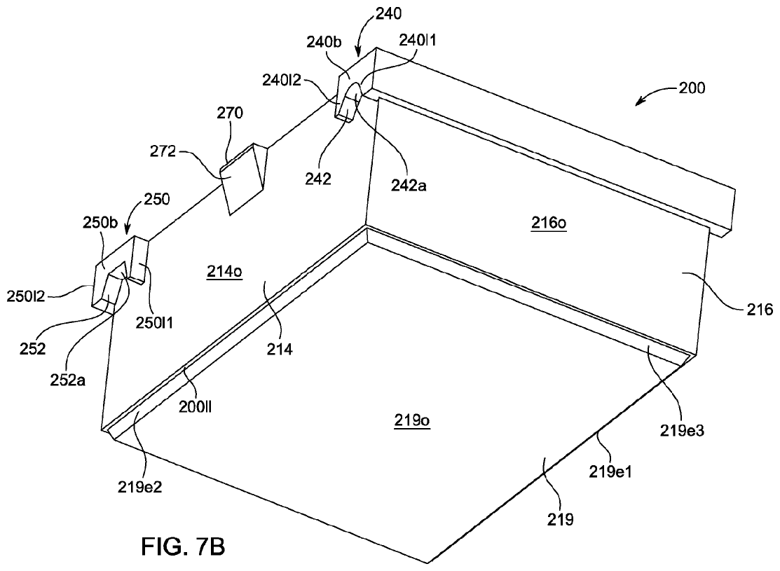

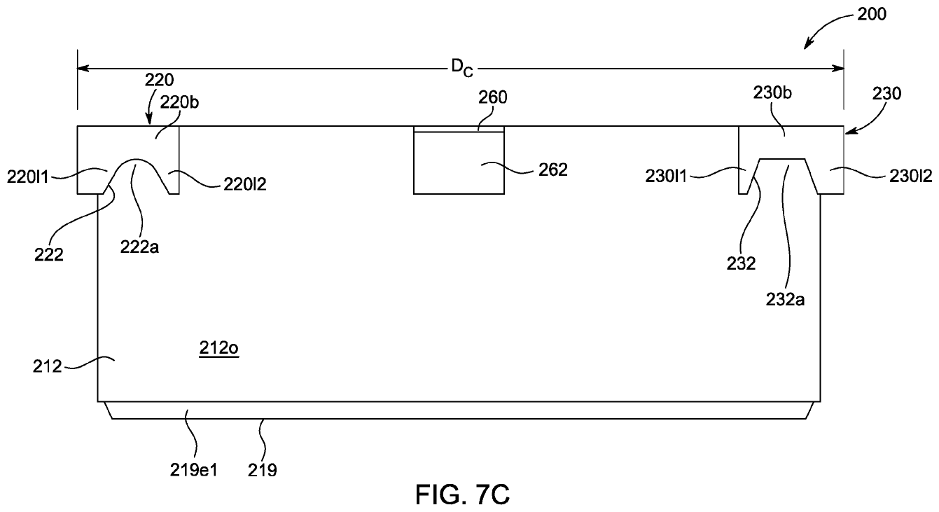

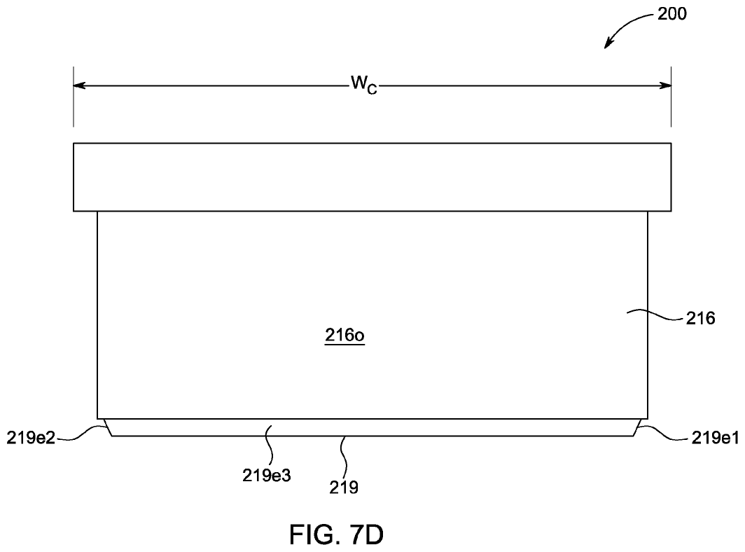

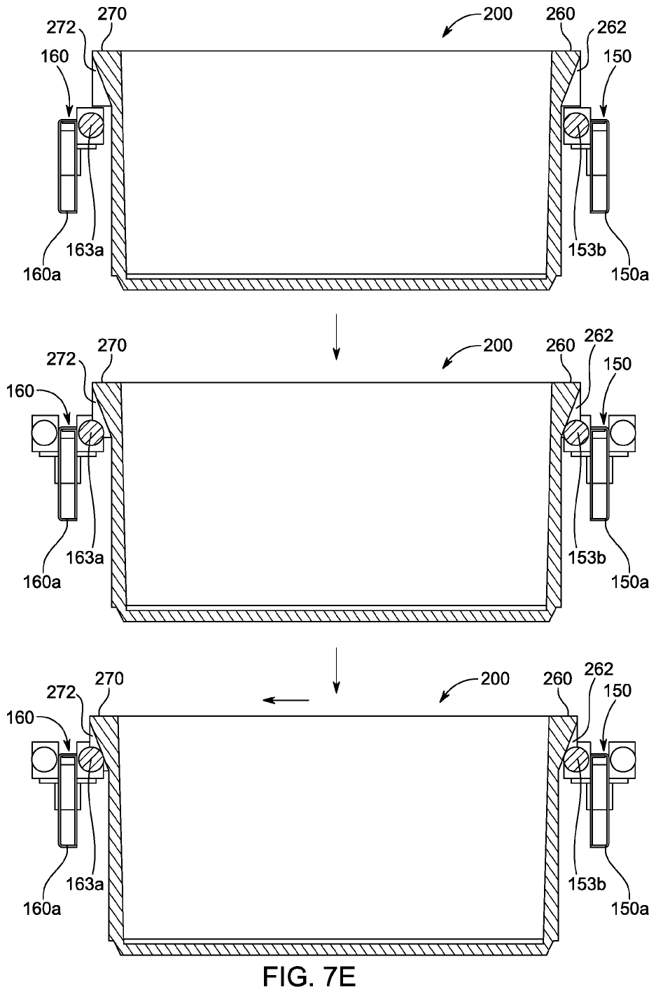

The containers 200, one of which is shown in FIGS. 7A-7D, act as storage locations for items and are configured to be transported by the vehicles 300 and loaded/unloaded by the vehicles 300 into/from the storage rack 100. The container 200 includes a first side wall 212; a second side wall 214; a front wall 216; a back wall 218; a bottom wall 219; first, second, third, and fourth rack engagers 220, 230, 240, and 250; and first and second centerer engagers 260 and 270. As best shown in FIGS. 7C and 7D, the container 200 has a width W_{C} and a depth D_{C}.

The walls are connected to one another so the first and second side walls 212 and 214 are opposite one another; the front and back walls 216 and 218 are opposite one another, connect and extend between the first and second side walls 212 and 214, and are transverse to the first and second side walls 212 and 214; and the bottom wall 219 is connected to the bottom edges of, extends between, and is transverse to the first and second side walls 212 and 214 and the front and back walls 216 and 218. The interior surfaces 2120, 2140, 2160, 2180, and 2190 of these walls together define an item-storage area (not labeled) in which one or more items may be stored.

The walls of the container 200 are sized, shaped, positioned, oriented, and otherwise configured so multiples containers 200 can be stacked atop one another when stored in one of the storage areas SA of the storage rack 100. Specifically, the upper edges of the first and second side walls 212 and 214 and the front and back walls 216 and 218 together form an upper lip 200ul, best shown in FIG. 7A. Portions of the lower edges of the first and second side walls 212 and 214 and the front and back walls 216 and 218 together form a lower lip 200ll, best shown in FIG. 7B. As best shown in FIGS. 7C and 7D, the edges 219e1-219e4 of the bottom wall 219 are angled inward toward the center of the container 200 extending downward from where they connect to the first and second side walls 212 and 214 and the front and back walls 216 and 218. When a first container is stacked atop a second container, the lower lip of the first container engages and is supported by the upper lip of the second container, and part of the bottom wall 219 (including the angled edges 219e1-219e4) are received by the second container. This partial nesting provides additional lateral support to prevent the first container from moving horizontally in the X- or Y-directions when stacked atop the second container.

The rack engagers 220, 230, 240, and 250 are sized, shaped, positioned, oriented, and otherwise configured to engage the set of container supports of a given storage area SA of the storage rack 100 when the container 200 is loaded into and stored in that storage area. The first and second rack engagers 220 and 230 are connected to (and in this example embodiment, integrally formed with) the first side wall 212, and the third and fourth rack engagers 240 and 250 are connected to (and in this example embodiment, integrally formed with) the second side wall 214.

The first rack engager 220 includes a base 220b and spaced-apart first and second legs 220l1 and 220l2 extending downward in the Z-direction from the base 220b. The base 220b and the legs 220l1 and 220l2 form an engagement surface 222 and define a support-receiving area 222a therebetween. The second rack engager 230 includes a base 230b and spaced-apart first and second legs 230l1 and 230l2 extending downward in the Z-direction from the base 230b. The base 230b and the legs 230l1 and 230l2 form an engagement surface 232 and define a support-receiving area 232a therebetween. The third rack engager 240 includes a base 240b and spaced-apart first and second legs 240l1 and 240l2 extending downward in the Z-direction from the base 240b. The base 240b and the legs 240l1 and 240l2 form an engagement surface 242 and define a support-receiving area 242a therebetween. The fourth rack engager 250 includes a base 250b and spaced-apart first and second legs 250l1 and 250l2 extending downward in the Z-direction from the base 250b. The base 250b and the legs 250l1 and 250l2 form an engagement surface 252 and define a support-receiving area 252a therebetween. In this example embodiment, the engagement surfaces are all concave surfaces, though in other embodiments zero, only one, only two, or only three of the engagement surfaces are concave surfaces. The concave shape enables the engagement surfaces to guide a container support into the support-receiving area if the support-receiving area is not exactly horizontally aligned with the container support before the container is lowered, as described below. The support-receiving areas are sized, shaped, and otherwise configured to receive the container supports of the storage rack 100.

The first centerer engager 260 is connected to (and in this example embodiment, integrally formed with) the first side wall 212 near the upper lip 200ul and between the first and second rack engagers 220 and 230. The first centerer engager 260 includes a downward-sloping wall 262. The second centerer engager 270 is connected to (and in this example embodiment, integrally formed with) the second side wall 214 near the upper lip 200ul and between the third and fourth rack engagers 240 and 250. The second centerer engager 270 includes a downward-sloping wall 272.

The centerer engagers 260 and 270 are sized, shaped, positioned, oriented, and otherwise configured to center the container 200 in the X-direction between two adjacent dividers when being lowered onto the set of container supports of a given storage area of the storage rack 100. For instance, FIG. 7E shows the centerer engager 260 engaging the container support 153b and forcing the container 200 to move slightly in the X-direction while descending onto the container supports of the storage area SA3.

This is merely one example of the container 200, and the container may have any other suitable configuration.

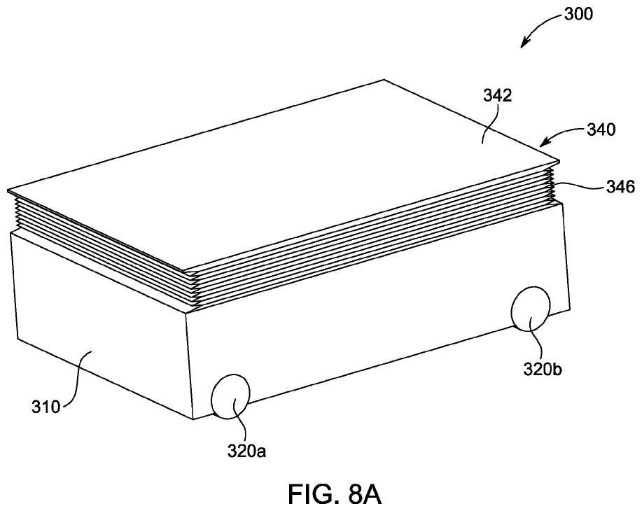

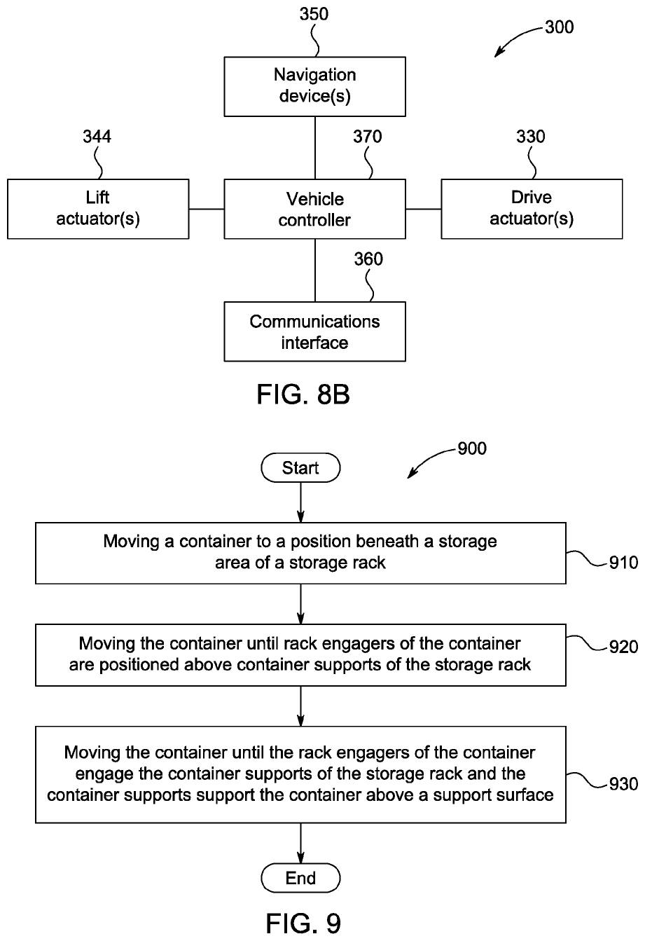

The vehicles 300, one of which is shown in FIGS. 8A and 8B, are configured to transport containers 200 to and from the storage rack 100, load the containers 200 into storage areas SA of the storage rack 100 for storage, and unload the containers 200 from the storage areas SA of the storage rack 100. The vehicle 300 includes a chassis 310, multiple wheels including wheels 320a and 320b, a drive actuator 330, a lift assembly 340, one or more navigation devices 350, a network interface 360, a vehicle controller 370, and a power source.

The chassis 310 includes any suitable frame configured to support the other components of the vehicle 300. The wheels are rotatably supported by the chassis 310 in any suitable manner, such as via suitable axles and bearings. The drive actuator 330 includes one or more electric motors or other suitable prime mover(s) operably connected to one or more of the wheels via a suitable drive train (not shown) and configured to drive the wheels to move the vehicle 300 in the X- and Y-directions. In other embodiments, the vehicle is configured to move in only one direction (such as the Y-direction).

The lift assembly 340 includes a lift device 342, a lift actuator 344, and an expandable/collapsible bellows 346. The lift device 342 includes any suitable components sized, shaped, positioned, oriented, and otherwise configured to receive the container 200. In this example embodiment, the lift device 342 includes a platform. The lift actuator 344 includes any suitable actuator, such as a scissor lift or one or more linear actuators, supported by the chassis 310 and operably connected to the lift device 342 and configured to raise and lower the lift device 342 relative to the chassis 310. FIG. 8A shows the lift device 342 in a home (lower) position. The expandable/collapsible bellows 346 extends between the lift device 342 and the chassis 310 and expands/contracts as the lift device ascends/descends to prevent interference with the lift actuator 344.

In certain embodiments, the upper surface of the lift device is formed from a high-friction material, is textured, and/or is coated with a high-friction material to increase the friction force between the lift device and a container on the lift device. In various embodiments, a portion of the lift device is recessed and sized to receive part of the bottom wall of the container. This enables the container to partially nest into the lift device, providing additional stability as the vehicle moves around while carrying the container.

In certain embodiments, the lift device includes a container-retaining system movable between an engaged configuration in which the container-retaining system engages a container when positioned on the lift device and a disengaged configuration in which the container-retaining system does not engage the container when positioned on the lift device. In these embodiments, the AS/RS control system or the vehicle controller is configured to control the container-retaining system and move the container-retaining system between the two configurations. When the container-retaining system is in the engaged configuration, the container-retaining system engages the container to retain the container on the lift device. For instance, in one example embodiment, the container-retaining system includes two opposing arms and an actuator operably connected to the arms to move the arms toward and away from one another to engage and disengage a container on the lift device. In another example embodiment, part of the container (such as part of the bottom wall) is magnetic, and the container-retaining system includes an electromagnet that can be energized to engage the container via magnetic attraction and deenergized to disengage the container. There are merely two examples of a container-retaining system, and any suitable system may be employed.

The navigation devices 350 include any suitable devices used to guide the vehicle 300. These devices can include (but are not limited to): magnetic sensors, laser sensors, gyroscopes, optical sensors, global positioning system receivers, radio-frequency identification sensors, near-field communication sensors, and/or proximity sensors.

The communications interface 360 is configured to establish and facilitate bidirectional communication between the vehicle controller 370 (described below) and an external device, such as the AS/RS control system C (described below). In operation, once the communications interface 360 establishes communication with the external device, the vehicle controller 370 can send data (via the communications interface 360) associated with the operation of the vehicle 300 to the external device and receive data (via the communications interface 360) from the external device. The communications interface 360 may be any suitable wired or wireless communication interface having any suitable architecture and utilizing any suitable protocol such as, but not limited to: 802.11 (Wi-Fi); 802.15 (including Bluetooth); 802.16 (WiMAX); 802.22; cellular standards such as CDMA, CDMA2000, and WCDMA; radio frequency (e.g., RFID); infrared; and near-field communication (NFC) protocols.

The vehicle controller 370 includes a processing device (or devices) communicatively connected to a memory device (or devices). For instance, the vehicle controller 370 may be a programmable logic controller. The processing device may include any suitable processing device such as, but not limited to, a general-purpose processor, a special-purpose processor, a digital-signal processor, one or more microprocessors, one or more microprocessors in association with a digital-signal processor core, one or more application-specific integrated circuits, one or more field-programmable gate array circuits, one or more integrated circuits, and/or a state machine. The memory device may include any suitable memory device such as, but not limited to, read-only memory, random-access memory, one or more digital registers, cache memory, one or more semiconductor memory devices, magnetic media such as integrated hard disks and/or removable memory, magneto-optical media, and/or optical media. The memory device stores instructions executable by the processing device to control operation of the vehicle controller 370. The vehicle controller 370 is communicatively and operably connected to the drive actuator 330, the lift actuator 344, the navigation devices 350, and the network interface 360 to receive signals from and to control those components.

The power source may be a battery or any other suitable component configured to power the actuators and other electrically powered components of the vehicle 300. In other embodiments, the power source is not part of the vehicle 300.

The illustrated vehicle 300 is merely one example vehicle, and any suitable vehicle having any suitable configuration may be used in conjunction with the storage rack 100 and the containers 200, so long as the vehicle is configured to carry out the loading and unloading processes described below.

The AS/RS control system C includes a processing device (or devices) communicatively connected to a memory device (or devices). For instance, the controller may be a programmable logic controller. The processing device may include any suitable processing device such as, but not limited to, a general-purpose processor, a special-purpose processor, a digital-signal processor, one or more microprocessors, one or more microprocessors in association with a digital-signal processor core, one or more application-specific integrated circuits, one or more field-programmable gate array circuits, one or more integrated circuits, and/or a state machine. The memory device may include any suitable memory device or computer-readable medium such as, but not limited to, read-only memory, random-access memory, one or more digital registers, cache memory, one or more semiconductor memory devices, magnetic media such as integrated hard disks and/or removable memory, magneto-optical media, and/or optical media.

The memory device stores instructions executable by the processing device to control operation of the AS/RS 10 to carry out the loading and unloading processes 900, 1100, 1300, and 1500 described below. The AS/RS control system C is communicatively and operably connected to the vehicles 300 to receive signals from and to control those vehicles 300. For instance, the AS/RS control system C may include a database for keeping track of the containers 200, including their contents and their locations (both the particular storage area and the particular location in the stack of containers at that storage area); a routing planner for finding optimal routes for the vehicles 300; and a communications interface for communicating instructions to the vehicles 300 (and particularly, to the vehicle controllers 370). The AS/RS control system C typically communicates with a central computer where orders and tasks are transmitted to the AS/RS control system C.

Operation of the AS/RS 10 to load and unload the containers 200 into the storage rack 100 using the vehicles 300 is now described with respect to FIGS. 9-16D.

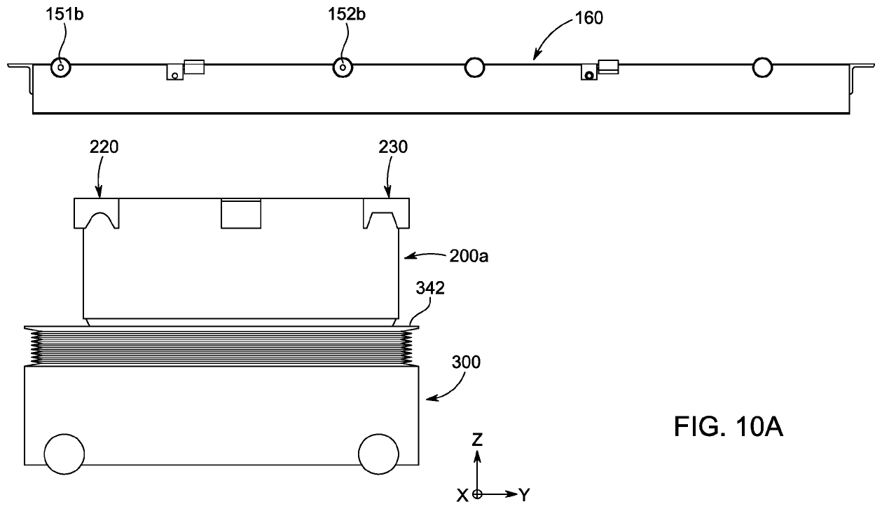

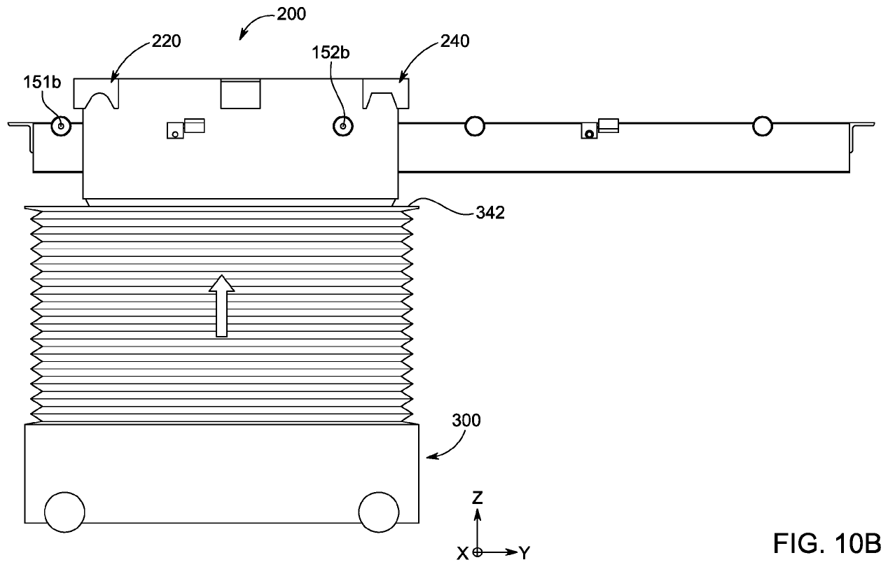

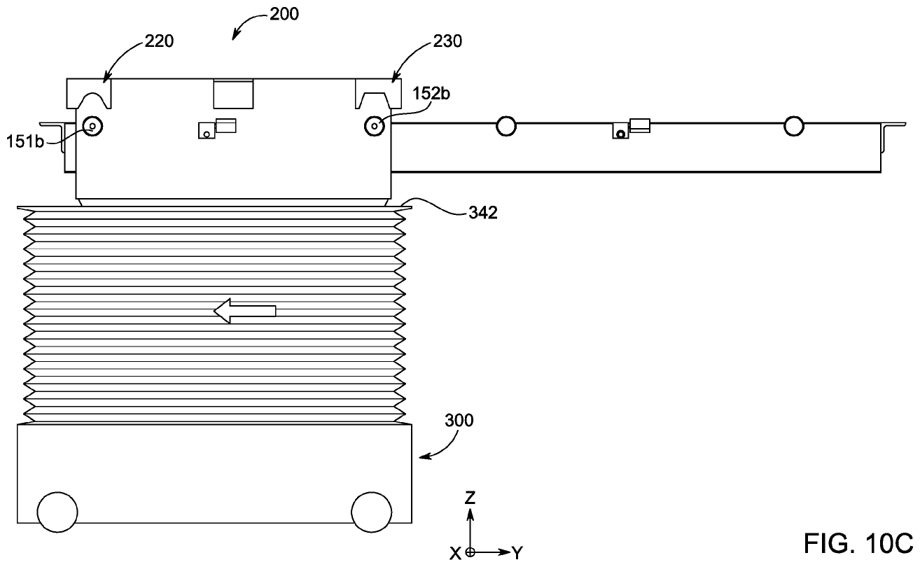

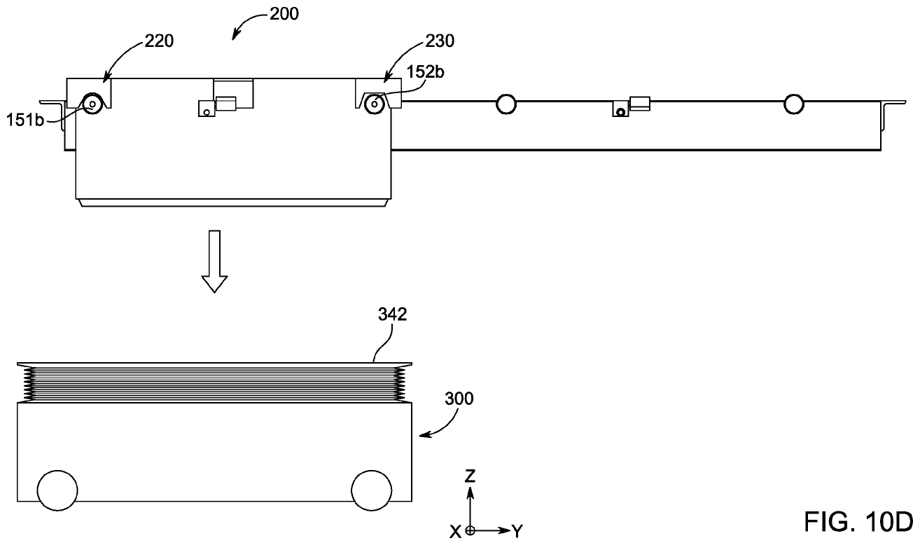

FIG. 9 is a flowchart showing a method 900 of loading a container onto the storage rack and into an empty storage area of the storage rack. A particular example of the AS/RS 10 carrying out the method 900 is shown in FIGS. 10A-10D and described below.

The method 900 begins by moving a container to a position beneath a storage area of a storage rack, as block 910 indicates. For example, a first container 200a filled with items is positioned (such as via an operator or an automated system) on the lift device 342 of a vehicle 300, as shown in FIG. 10A. With the lift device 342 in its home (lower) position, the vehicle 300 moves in the X-and/or Y-directions beneath the storage area SA3 of the storage rack 100 so the rack engagers 220, 230, 240, and 250 of the first container 200a are horizontally offset from the container supports 151b, 152b, 161a, and 162a, respectively, of the storage rack 100, as also shown in FIG. 10A. In this context, when a rack engager is “horizontally offset” from a container support, the rack engager is not directly below the container support so the rack engager does not engage the container support when the container is raised.

The method 900 continues by moving the container until rack engagers of the container are above container supports of the storage rack, as block 920 indicates. Continuing with the above example, the lift actuator 344 raises the lift device 342 until the rack engagers 220, 230, 240, and 250 of the first container 200a are above the container supports 151b, 152b, 161a, and 162a, respectively, as shown in FIG. 10B. Because the rack engagers were horizontally offset from the container supports, the rack engagers did not contact the container supports as the container was raised. The vehicle 300 moves horizontally in the Y-direction until the rack engagers 220, 230, 240, and 250 of the first container 200a are above and horizontally aligned with the container supports 151b, 152b, 161a, and 162a, respectively, as shown in FIG. 10C. In this context, when a rack engager is “horizontally aligned” with a container support, the rack engager is above the container support so the engagement surface of the rack engager can engage the container support when the container is lowered. While the vertical and horizontal movements are shown as being separate in this example, in other embodiments they may be performed together during all or part of the time the container is moving so the container moves along one or more diagonal paths.

The method 900 concludes by moving the container until the rack engagers of the container engage the container supports of the storage rack and the container supports support the container above a support surface, as block 930 indicates. Continuing with the above example, the lift actuator 344 lowers the lift device 342 to its home (lower) position. The first container 200a initially travels with the lift device 342. Eventually, this descent of the first container 200a relative to the container supports 151b, 152b, 161a, and 162a results in the engagement surfaces 222, 232, 242, and 252 of the rack engagers 220, 230, 240, and 250 engaging the container supports 151b, 152b, 161a, and 162a, respectively. As the lift device 342 (and the first container 200a thereon) continues descending, the mass of the first container 200a combined with the concave shapes of the engagement surfaces result in the engagement surfaces guiding the container supports 151b, 152b, 161a, and 162a into the support-receiving areas 222a, 232a, 242a, and 252a of the rack engagers 220, 230, 240, and 250, respectively. After the container supports 151b, 152b, 161a, and 162a are received by the rack engagers 220, 230, 240, and 250 of the first container 200a, continued descent of the lift device 342 results in the container supports supporting the first container 200a above the floor FL and the lift device 342 disengaging the first container 200a as it returns to its home (lower) position, as shown in FIG. 10D.

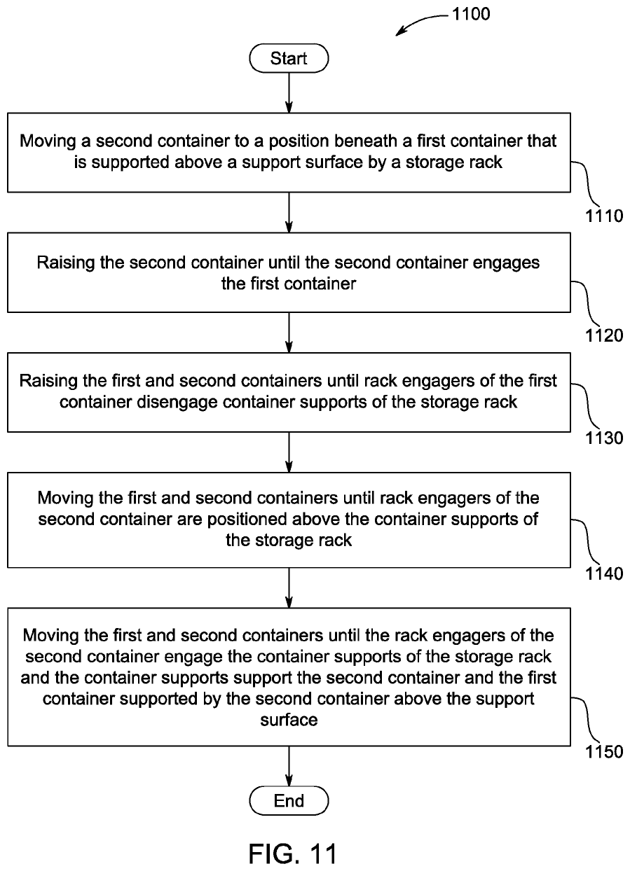

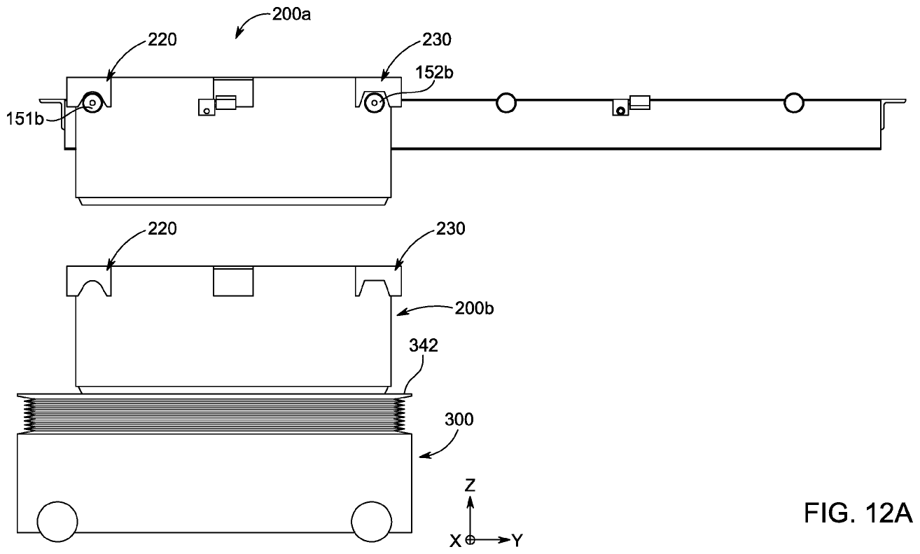

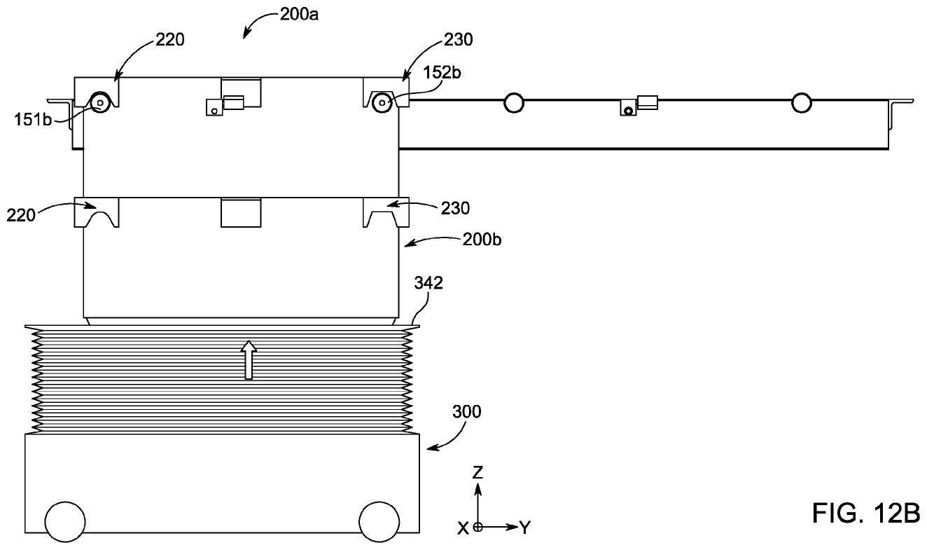

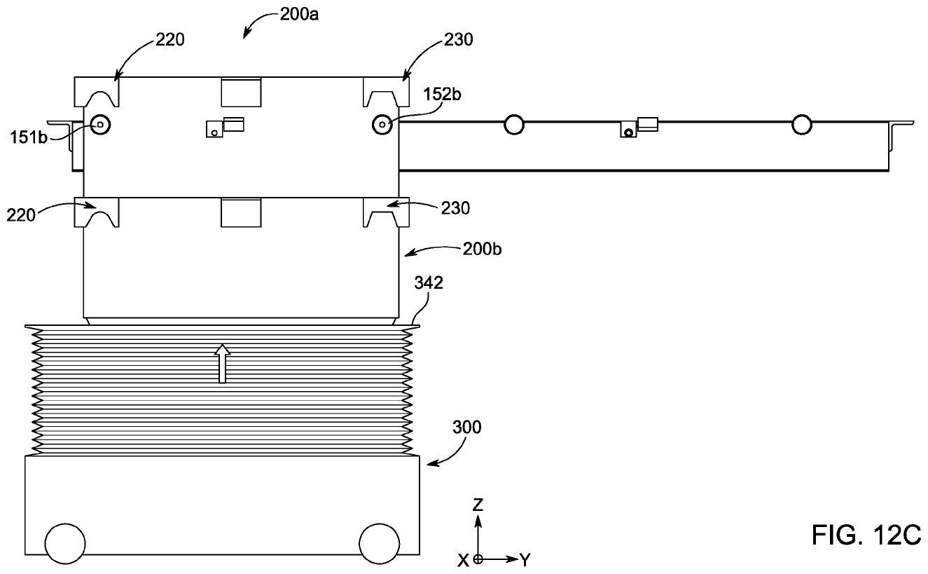

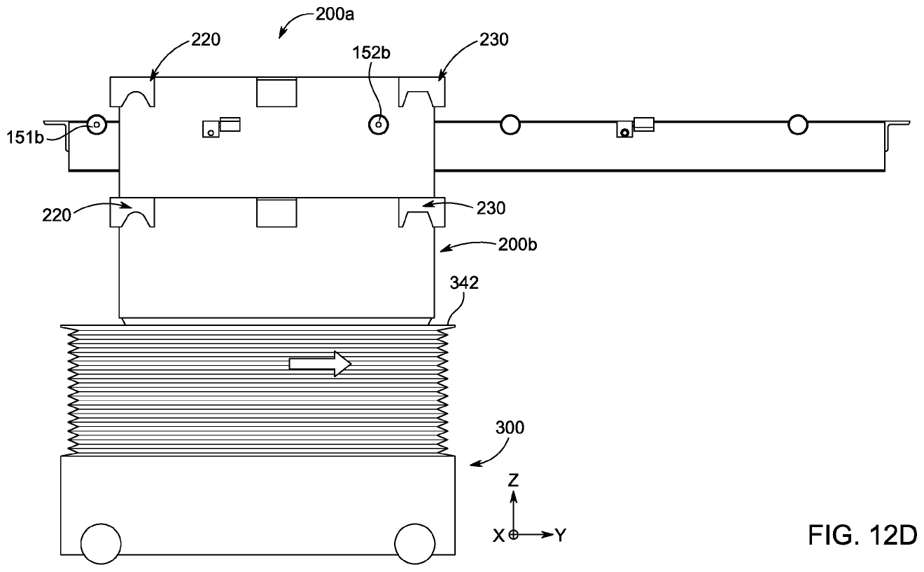

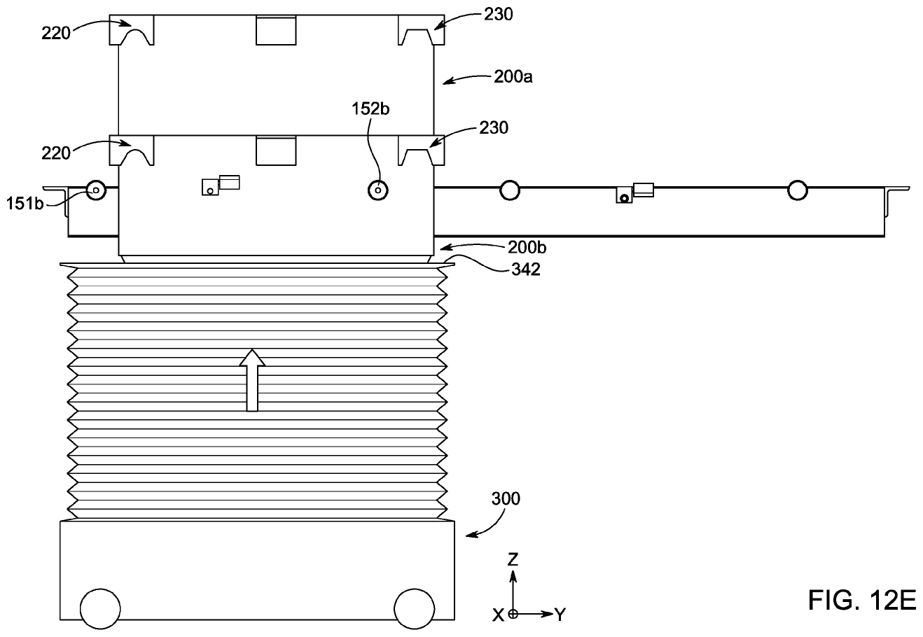

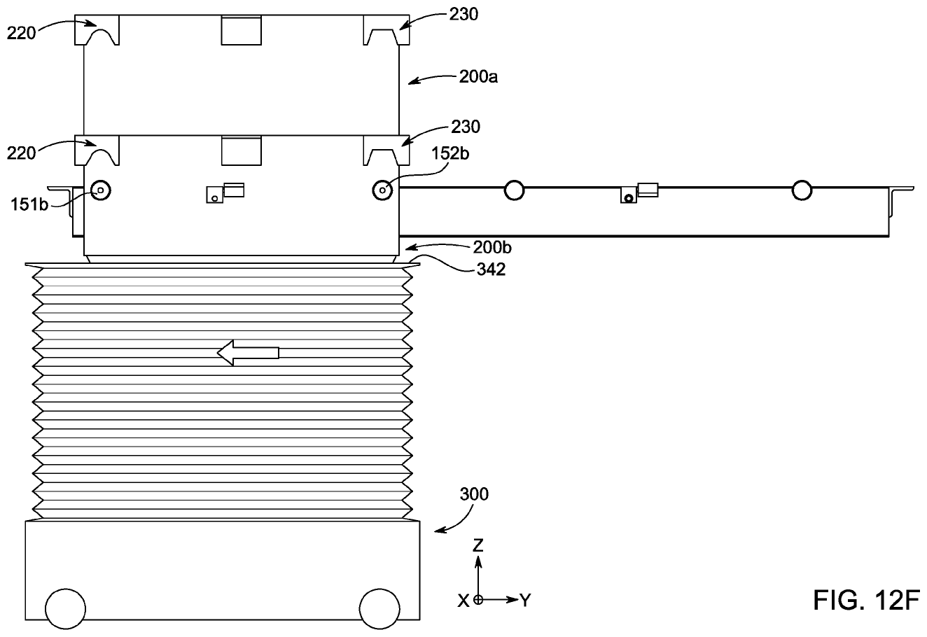

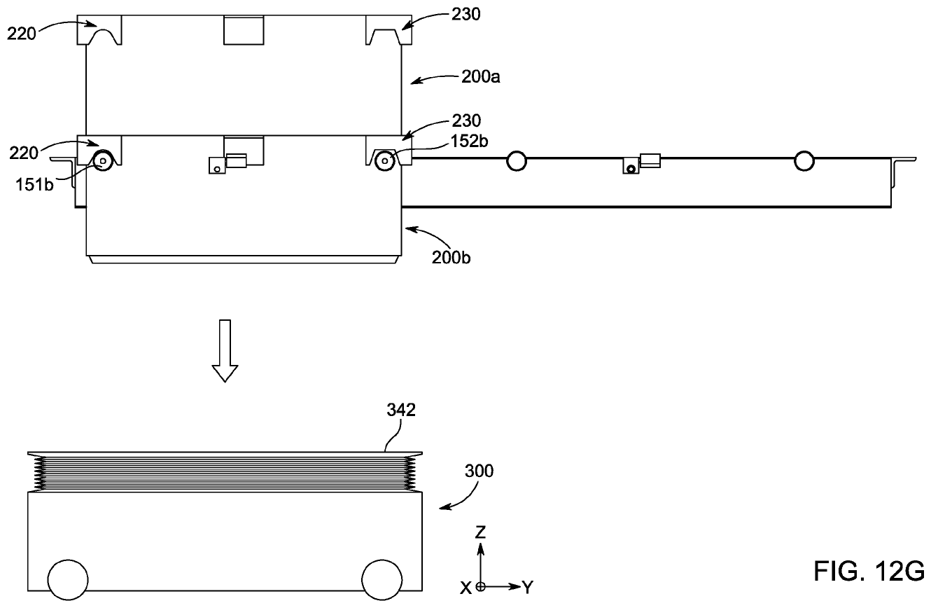

FIG. 11 is a flowchart showing a method of loading a container onto the storage rack and into a storage area occupied by one or more other containers. A particular example of the AS/RS 10 carrying out the method 1100 is shown in FIGS. 12A-12G and described below.

The method 1100 begins by moving a second container to a position beneath a first container supported above a support surface by a storage rack, as block 1110 indicates. For example, a second container 200b filled with items is positioned (such as via an operator or an automated system) on the lift device 342 of the vehicle 300, as shown in FIG. 12A. In other embodiments, one or more additional containers are stacked atop the second container 200b. With the lift device 342 in its home (lower) position, the vehicle 300 moves in the X-and/or Y-directions beneath the storage area SA3 of the storage rack 100—and the first container 200a stored there—so the rack engagers 220, 230, 240, and 250 of the second container 200b are horizontally aligned with the container supports 151b, 152b, 161a, and 162a, respectively, of the storage rack 100, as also shown in FIG. 12A.

The method 1100 continues by raising the second container until the second container engages the first container, as block 1120 indicates. Continuing with the above example, the lift actuator 344 begins raising the lift device 342. As the lift device 342 and the second container 200b ascend, the upper lip 200ul of the second container 200b engages the lower lip 200ll of the first container 200a and the first container 200a partially nests in the second container 200b, as described above and as shown in FIG. 12B.

The method 1100 continues by raising the first and second containers until rack engagers of the first container disengage container supports of the storage rack, as block 1130 indicates. Continuing with the above example, the lift actuator 344 continues raising the lift device 342 until the container supports 151b, 152b, 161a, and 162a are removed from the rack engagers 220, 230, 240, and 250, respectively, of the first container 200a and the rack engagers are above the container supports, as shown in FIG. 12C.

The method 1100 continues by moving the first and second containers until rack engagers of the second container are above the container supports of the storage rack, as block 1140 indicates. Continuing with the above example, the vehicle 300 moves horizontally in the Y-direction until the rack engagers 220, 230, 240, and 250 of the second container 200b are horizontally offset from the container supports 151b, 152b, 161a, and 162a, respectively, as shown in FIG. 12D. The lift actuator 344 raises the lift device 342 to until the rack engagers 220, 230, 240, and 250 of the second container 200b are above the container supports 151b, 152b, 161a, and 162a, respectively, as shown in FIG. 12E.

Because the rack engagers were horizontally offset from the container supports, the rack engagers did not contact the container supports as the second container was raised. The vehicle 300 moves horizontally in the Y-direction until the rack engagers 220, 230, 240, and 250 of the second container 200b are above and horizontally aligned with the container supports 151b, 152b, 161a, and 162a, respectively, as shown in FIG. 12F. While the vertical and horizontal movements are shown as being separate in this example, in other embodiments they may be performed together during all or part of the time the container is moving so the container moves along one or more diagonal paths.

The method 1100 concludes by moving the first and second containers until the rack engagers of the second container engage the container supports of the storage rack and the container supports support the second container and the first container supported by the second container above support surface, as block 1050 indicates. Continuing with the above example, the lift actuator 344 lowers the lift device 342 to its home (lower) position. The first and second containers 200a and 200b initially travel with the lift device 342. Eventually, this descent of the containers relative to the container supports 151b, 152b, 161a, and 162a results in the engagement surfaces 222, 232, 242, and 252 of the rack engagers 220, 230, 240, and 250 of the second container 200b engaging the container supports 151b, 152b, 161a, and 162a, respectively. As the lift device 342 (and the containers thereon) continues descending, the mass of the first and second containers 200a and 200b combined with the concave shapes of the engagement surfaces result in the engagement surfaces guiding the container supports 151b, 152b, 161a, and 162a into the support-receiving areas 222a, 232a, 242a, and 252a of the rack engagers 220, 230, 240, and 250, respectively, of the second container 200b. After the container supports 151b, 152b, 161a, and 162a are received by the rack engagers 220, 230, 240, and 250 of the second container 200b, continued descent of the lift device 342 results in the container supports supporting the second container 200b-and the first container 200a supported by the second container 200b-above the floor FL and the lift device 342 disengaging the second container 200b as it returns to its home (lower) position, as shown in FIG. 12G.

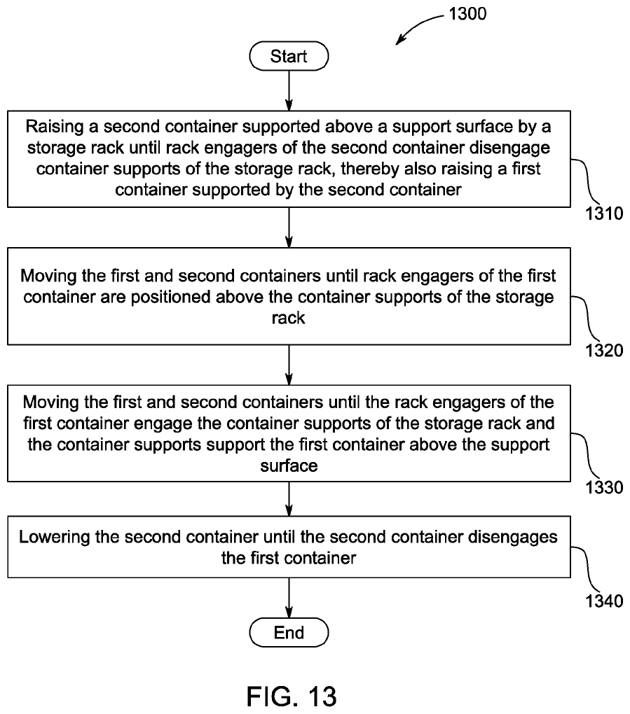

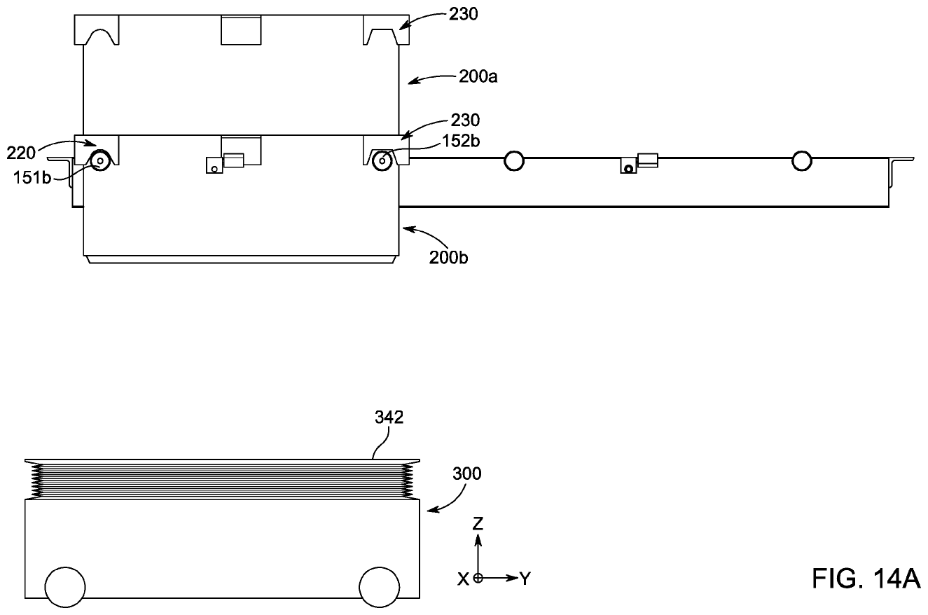

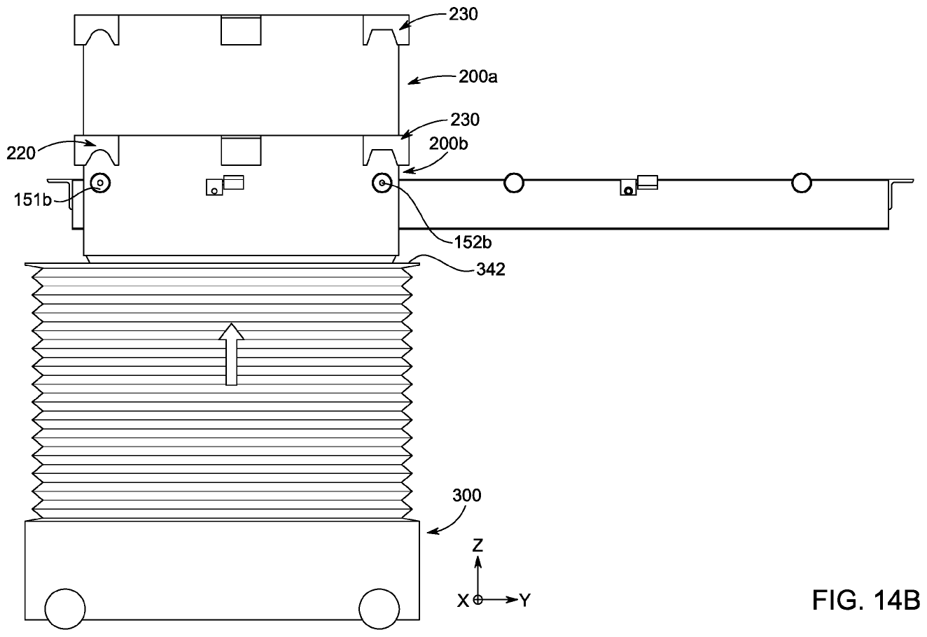

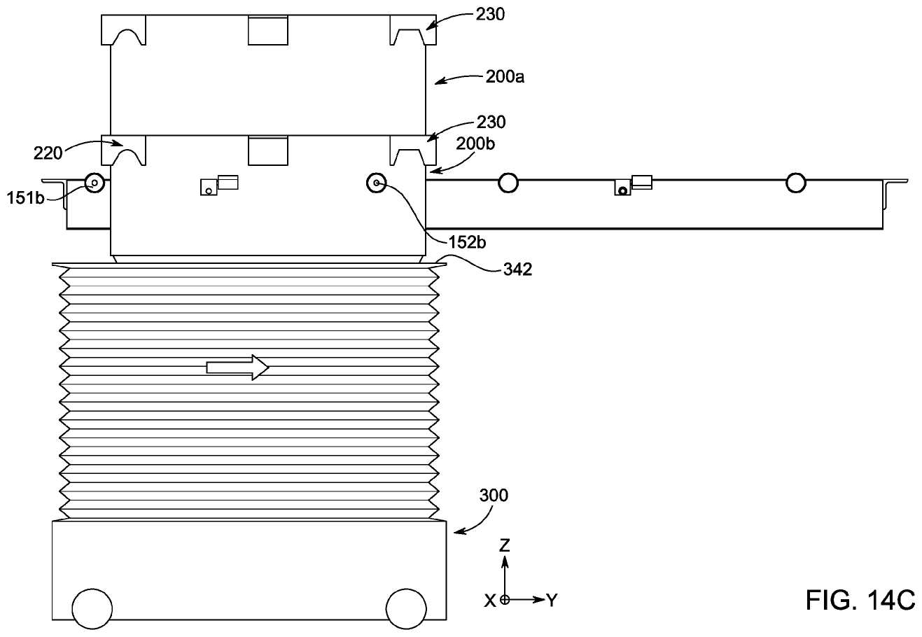

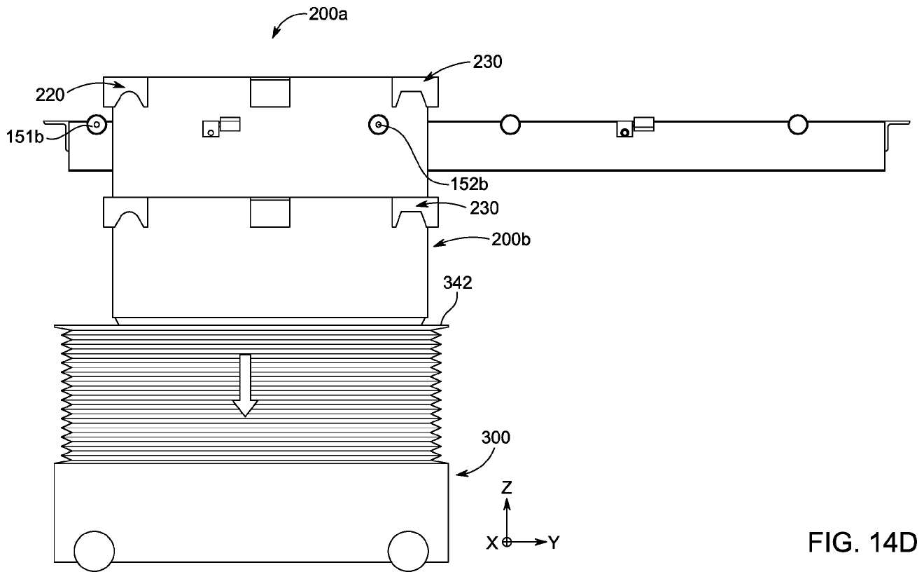

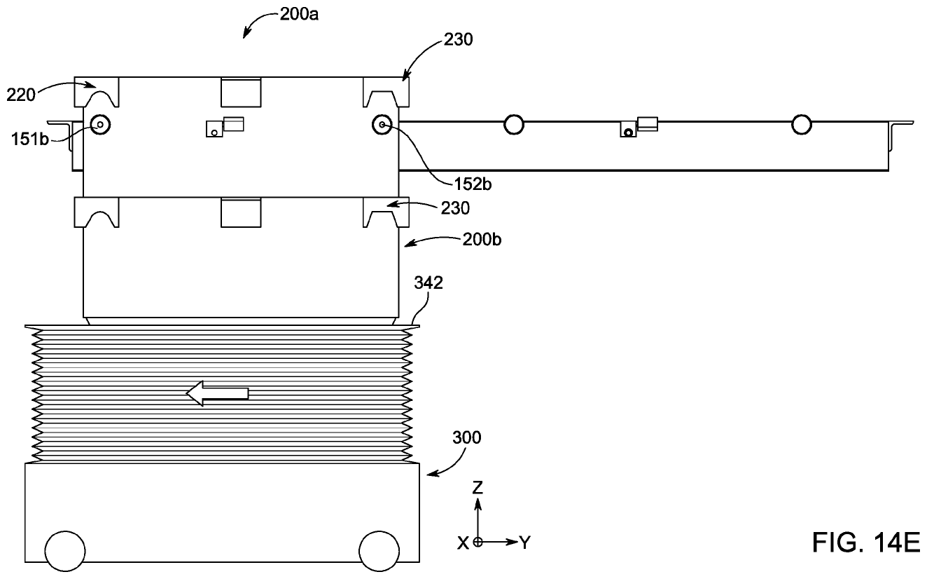

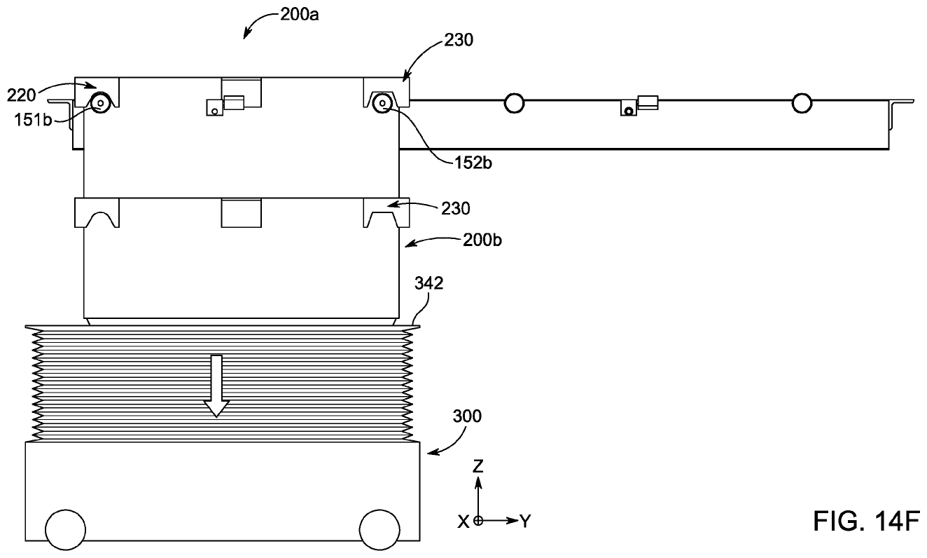

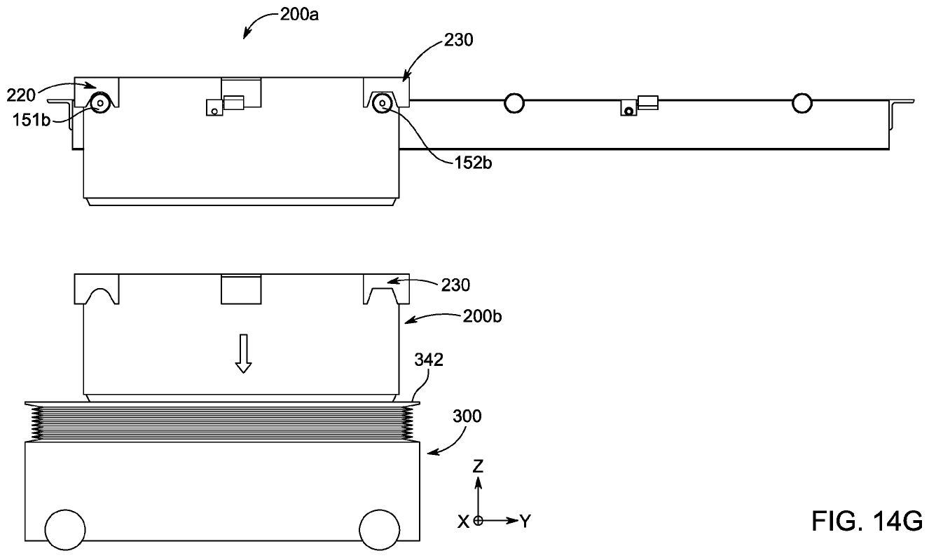

FIG. 13 is a flowchart showing a method 1300 of unloading a container from a storage rack when the container supports another container. A particular example of the AS/RS 10 carrying out the method 1300 is shown in FIGS. 14A-14G and described below.

The method 1300 begins by raising a second container supported above a support surface by a storage rack until rack engagers of the second container disengage container supports of the storage rack, thereby also raising a first container supported by the second container, as block 1310 indicates. For example, a vehicle 300 (with its lift device 342 in its home (lower) position) moves in the X-and/or Y-directions beneath the storage area SA3 of the storage rack 100 and the first and second containers 200a and 200b stored in that storage area, as shown in FIG. 14A. In other embodiments, one or more additional containers are stacked atop the first container 200a. The lift actuator 344 raises the lift device 342 to contact and thereafter raise the second container 200b (and the first container 200a supported by the second container 200b) until the container supports 151b, 152b, 161a, and 162a of the storage rack 100 are removed from the rack engagers 220, 230, 240, and 250, respectively, of the second container 200b and the rack engagers are above the container supports, as shown in FIG. 14B.

The method 1300 continues by moving the first and second containers until rack engagers of the first container are above the container supports of the storage rack, as block 1320 indicates. Continuing with the above example, the vehicle 300 moves horizontally in the Y-direction until the rack engagers 220, 230, 240, and 250 of the second container 200b are horizontally offset from the container supports 151b, 152b, 161a, and 162a, respectively, of the storage rack 100, as shown in FIG. 14C. The lift actuator 344 lowers the lift device 342 until the rack engagers 220, 230, 240, and 250 of the second container 200b are below the container supports 151b, 152b, 161a, and 162a of the storage rack and the rack engagers 220, 230, 240, and 250 of the first container 200a are above the container supports, as shown in FIG. 14D. Because the rack engagers were horizontally offset from the container supports, the rack engagers of the second container did not contact the container supports as the second container was lowered. The vehicle 300 moves horizontally in the Y-direction until the rack engagers 220, 230, 240, and 250 of the first container 200a are above and horizontally aligned with the container supports 151b, 152b, 161a, and 162a, respectively, of the storage rack 100, as shown in FIG. 14E. While the vertical and horizontal movements are shown as being separate in this example, in other embodiments they may be performed together during all or part of the time the container is moving so the container moves along one or more diagonal paths.

The method 1300 continues by moving the first and second containers until the rack engagers of the first container engage the container supports of the storage rack and the container supports support the first container above the support surface, as block 1330 indicates. Continuing with the above example, the lift actuator 344 begins lowering the lift device 342 to its home (lower) position. The first and second containers 200a and 200b initially travel with the lift device 342. Eventually, this descent of the containers relative to the container supports 151b, 152b, 161a, and 162a results in the engagement surfaces 222, 232, 242, and 252 of the rack engagers 220, 230, 240, and 250 of the first container 200a engaging the container supports 151b, 152b, 161a, and 162a, respectively. As the lift device 342 (and the containers thereon) continues descending, the mass of the first container 200a combined with the concave shapes of the engagement surfaces result in the engagement surfaces guiding the container supports 151b, 152b, 16la, and 162a into the support-receiving areas 222a, 232a, 242a, and 252a of the rack engagers 220, 230, 240, and 250, respectively, of the first container 200a. After the container supports 151b, 152b, 161a, and 162a are received by the rack engagers 220, 230, 240, and 250 of the first container 200a, continued descent of the lift device 342 results in the container supports supporting the first container 200a above the floor FL, as shown in FIG. 14F.

The method 1300 concludes by lowering the second container until the second container disengages the first container, as block 1340 indicates. Continuing with the above example, the lift actuator 344 continues lowering the lift device 342 to its home (lower) position. With the container supports supporting the first container 200a, this descent results in the second container 200b disengaging the first container 200a before the lift device 342 returns to its home (lower) position, as shown in FIG. 14G.

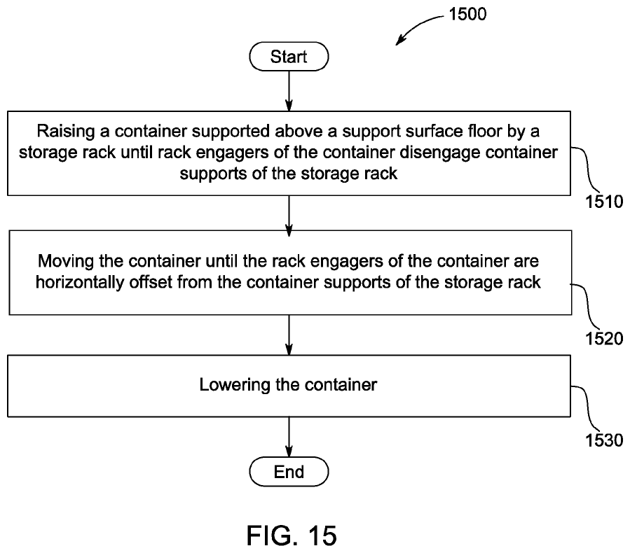

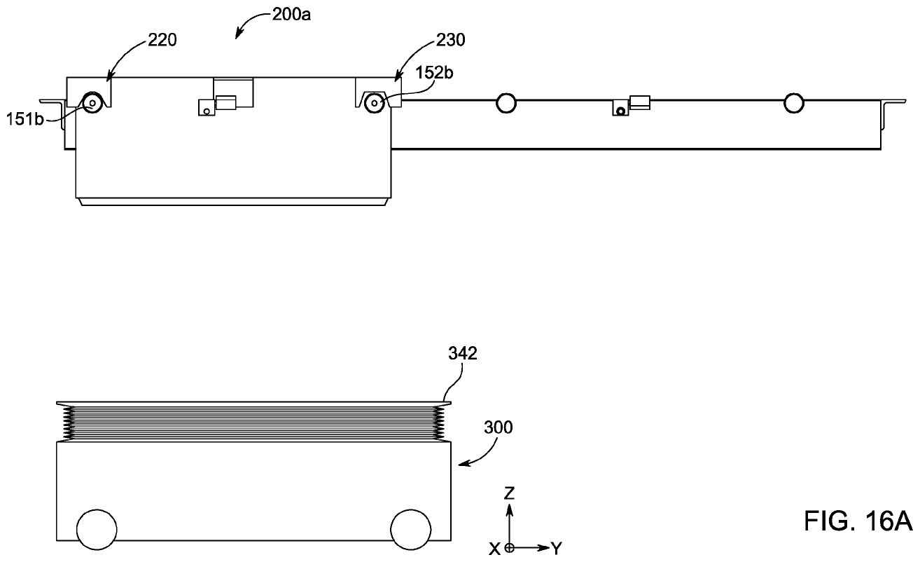

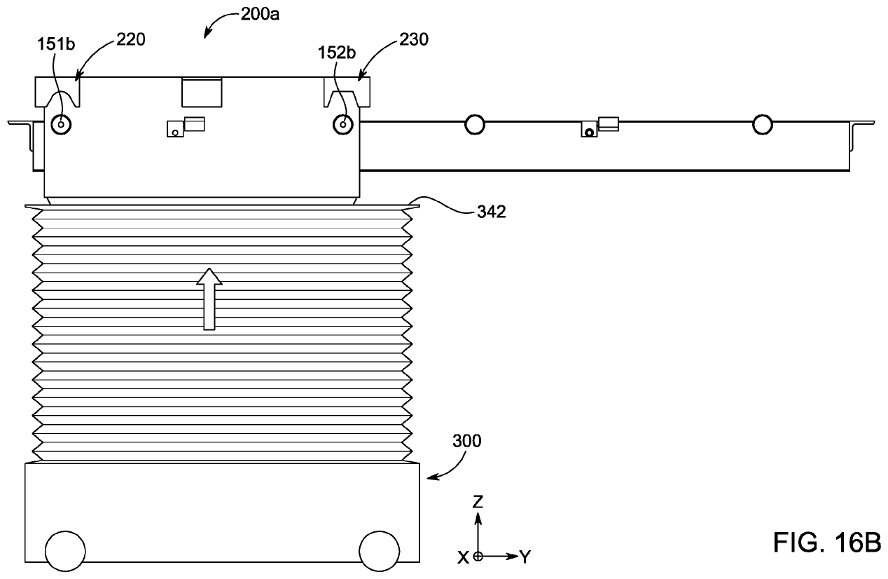

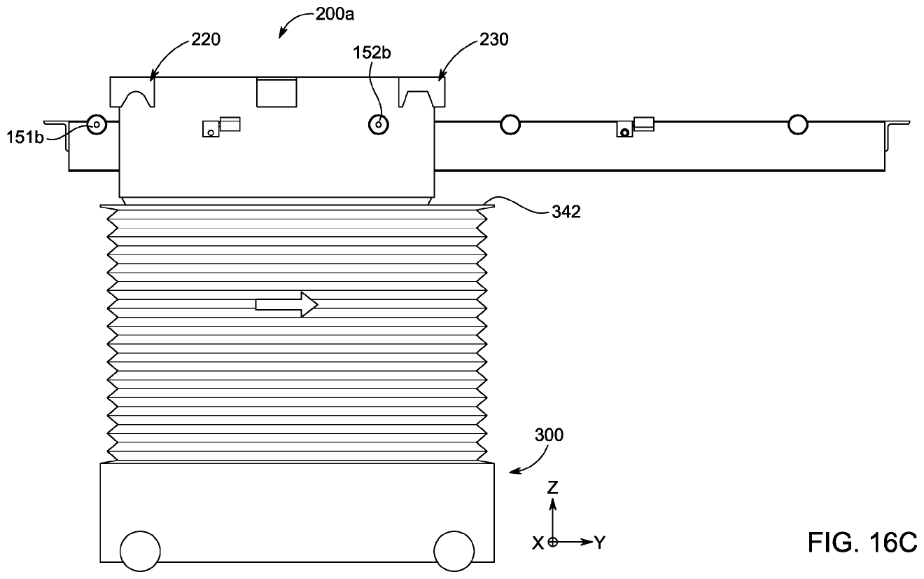

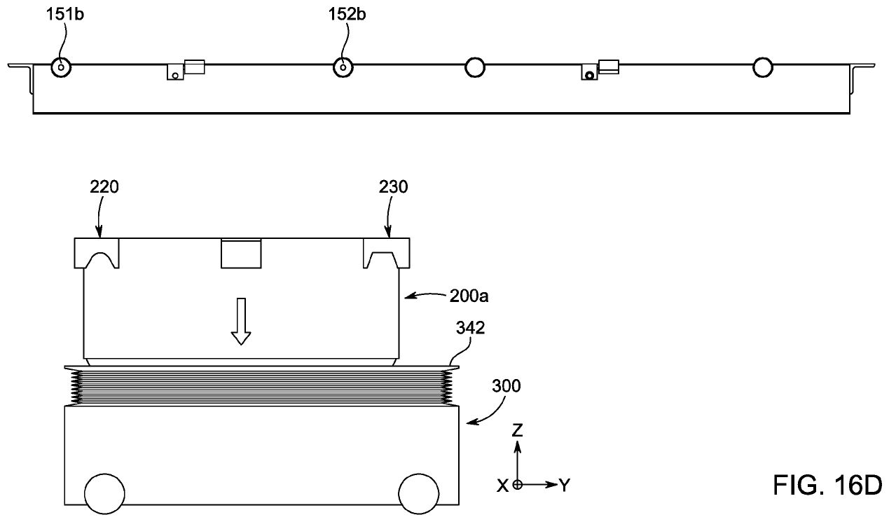

FIG. 15 is a flowchart showing a method 1500 of unloading a container from a storage rack when the container does not support any other containers. A particular example of the AS/RS 10 carrying out the method 1500 is shown in FIGS. 16A-16G and described below.

The method 1500 begins by raising a container supported above the floor by a storage rack until rack engagers of the container disengage container supports of the storage rack, as block 1510 indicates. For example, a vehicle 300 (with its lift device 342 in its home (lower) position) moves in the X-and/or Y-directions beneath the storage area SA3 of the storage rack 100 and the first container 200a stored in that storage area, as shown in FIG. 16A. The lift actuator 344 raises the lift device 342 to contact and thereafter raise the first container 200a until the container supports 151b, 152b, 161a, and 162a of the storage rack 100 are removed from the rack engagers 220, 230, 240, and 250, respectively, of the first container 200a and the rack engagers are above the container supports, as shown in FIG. 16B.

The method 1500 continues by moving the container until the rack engagers of the container are horizontally offset from the container supports of the storage rack, as block 1520 indicates. Continuing with the above example, the vehicle 300 moves horizontally in the Y-direction until the rack engagers 220, 230, 240, and 250 of the first container 200a are horizontally offset from the container supports 151b, 152b, 161a, and 162a, respectively, of the storage rack 100, as shown in FIG. 16C.

The method 1500 concludes by lowering the container, as block 1530 indicates. Continuing with the above example, the lift actuator 344 lowers the lift device 342 and the first container 200a thereon to its home (lower) position. Because the rack engagers were horizontally offset from the container supports, the rack engagers of the first container did not contact the container supports as the first container was lowered. While the vertical and horizontal movements are shown as being separate in this example, in other embodiments they may be performed together during all or part of the time the container is moving so the container moves along one or more diagonal paths.

In various embodiments, velocity of the lift device of the lift assembly of the vehicle in the Z-direction (i.e., vertically) is generally greater when the lift device does not support a container than when the lift device supports a container. In other words, in these embodiments, the lift device is raised more quickly when it does not support any containers than when it supports one or more containers. In various embodiments, the rate of acceleration and deceleration of the lift device in the Z-direction is generally greater when the lift device does not support a container than when the lift device supports a container. In other words, in these embodiments, the lift device is accelerated/decelerated to reach its desired velocity more quickly when it does not support any containers than when it supports one or more containers.

In various embodiments, velocity of the lift device of the lift assembly of the vehicle in the Z-direction is generally greater when the lift device supports only one container than when the lift device supports more than one container (e.g., two containers stacked atop one another). In other words, in these embodiments, the lift device is raised more quickly when it supports only one container than when it supports more than one container. In various embodiments, the rate of acceleration and deceleration of the lift device in the Z-direction is generally greater when the lift device supports only one container than when the lift device supports more than one container (e.g., two containers stacked atop one another). In other words, in these embodiments, the lift device is accelerated/decelerated to reach its desired velocity more quickly when it supports only one container than when it supports more than one container.

In various embodiments, velocity of the vehicle, the lift device, and/or the container (depending on the embodiment and the situation) in the Y-direction (i.e., horizontally) is generally greater when the lift device does not support a container than when the lift device supports a container. In other words, in these embodiments, the lift device is moved sideways more quickly when it does not support any containers than when it supports one or more containers. In various embodiments, the rate of acceleration and deceleration of the lift device in the Y-direction is generally greater when the lift device does not support a container than when the lift device supports a container. In other words, in these embodiments, the lift device is accelerated/decelerated to reach its desired velocity more quickly when it does not support any containers than when it supports one or more containers.

In various embodiments, velocity of the vehicle, the lift device, and/or the container (depending on the embodiment and the situation) in the Y-direction (i.e., horizontally) when the lift device supports only one container than when the lift device supports more than one container (e.g., two containers stacked atop one another). In other words, in these embodiments, the lift device is moved sideways more quickly when it supports only one container than when it supports more than one container. In various embodiments, the rate of acceleration and deceleration of the lift device in the Y-direction is generally greater when the lift device supports only one container than when the lift device supports more than one container (e.g., two containers stacked atop one another). In other words, in these embodiments, the lift device is accelerated/decelerated to reach its desired velocity more quickly when it supports only one container than when it supports more than one container.

In certain embodiments, a container that is not the bottommost container of a stack of containers in a storage area must be retrieved. There are several ways this may be carried out. In a first example, a single vehicle carries out this retrieval process. Here, the vehicle unloads the bottommost container in the stack (such as according to the method 1300), loads that container into another storage area (such as according to the method 900 if the storage area is unoccupied or the method 1100 if the storage area is occupied), and repeats this process until the to-be-retrieved container is the bottommost container of the stack. At that point, the vehicle unloads the to-be-retrieved container (such as according to the method 1300 if another container is atop that container or the method 1500 if that container is the only remaining container in the storage area). In another example, multiple vehicles carry out this retrieval process. Here, individual vehicles take turns unloading containers from the stack until a vehicle removes the to-be-retrieved container. Depending on the embodiment, after those vehicles remove a container, they may either load the container into another storage area or hold the container and re-load it into the same storage area after the to-be-retrieved container is removed.

In the above-described examples of the methods 900, 1100, 1300, and 1500 shown in FIGS. 10A-10D, 12A-12G, 14A-14G, and 16A-16D, the steps of moving the container(s) horizontally are carried out by moving the vehicle supporting the container(s). In other embodiments, the lift device of the vehicle is itself configured to move horizontally (under control of a suitable actuator) relative to the chassis of the vehicle. In these embodiments, the steps of moving the container(s) horizontally may be carried out by moving the lift device supporting the container(s). In further embodiments, the lift device of the vehicle includes a conveying device (such as an endless-loop conveyor) configured to move the container(s) horizontally (under control of a suitable actuator) relative to the lift device and the chassis of the vehicle. In these embodiments, the steps of moving the container(s) horizontally may be carried out by controlling the conveying device to move the container(s). In these alternative embodiments, the wheels of the vehicle may be locked against rotation while the containers are moved (either by moving the lift device itself or controlling a conveying device on the lift device). This prevents unwanted movement of the vehicle (and therefore unwanted movement of the container(s) supported by the vehicle) as the containers are being loaded or unloaded.

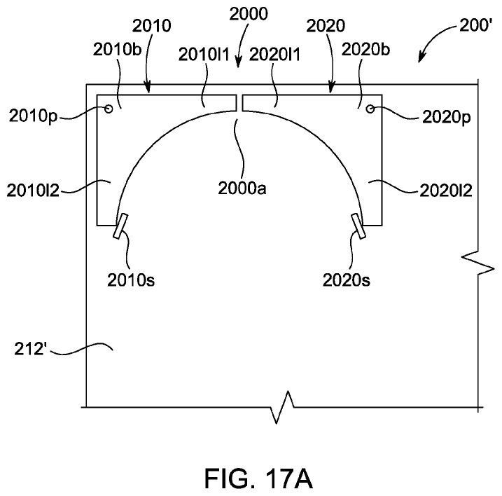

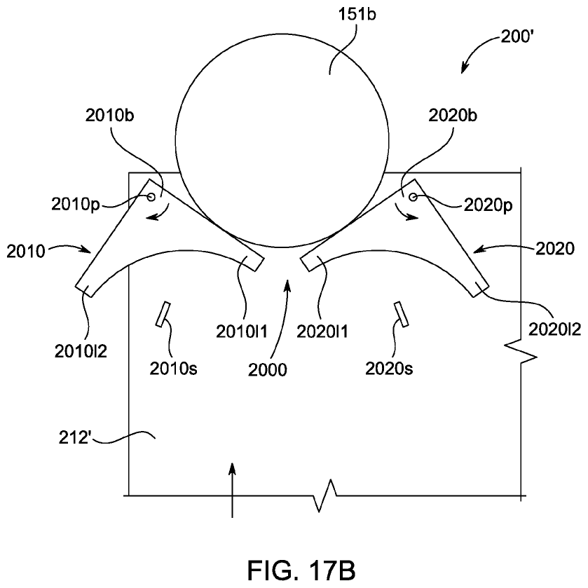

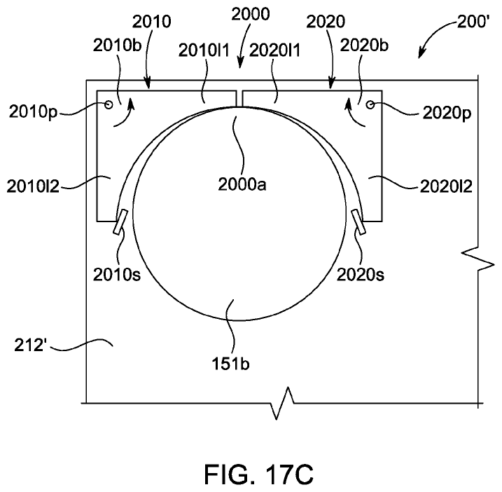

FIGS. 17A-17C show another embodiment of a container 200′. The container 200′ is the same as the container 200 described above and shown in FIGS. 7A-7D except that a rack engager 2000 is substituted for each rack engager 220, 230, 240, and 250. The rack engager 2000 includes a first wing 2010, a second wing 2020, a first stop 2010s, a second stop 2020s, a first biasing element (not shown), and a second biasing element (not shown).

The first wing 2010 includes a first base 2010b, a first engagement finger 2010l1 extending from the first base 2010b, and a first leg 201012 extending from the first base 2010b. The engagement finger and leg are oriented transversely to one another so the first wing 2010 forms an L shape. The first wing 2010 is pivotably mounted to the first side wall 212′ of the container 200′ via a first pivot 2010p. The first stop 2010s is connected to the first side wall 212′ and positioned so the first leg 2010l2 engages the first stop 2010s when the first wing 2010 is in a home position, as is shown in FIG. 17A. The first biasing element, which is a torsion spring in this example but may be any other suitable biasing element, is operably connected to the first wing 2010 to bias the first wing 2010 to its home position (and therefore biases the first leg 2010l2 into contact with the first stop 2010s).

Similarly, the second wing 2020 includes a second base 2020b, a second engagement finger 2020l1 extending from the second base 2020b, and a second leg 2020l2 extending from the second base 2020b. The engagement finger and leg are oriented transversely to one another so the second wing 2020 forms an L shape. The second wing 2020 is pivotably mounted to the first side wall 212′ of the container 200′ via a second pivot 2020p. The second stop 2020s is connected to the first side wall 212′ and positioned so the second leg 2020l2 engages the second stop 2020s when the second wing 2020 is in a home position, as is shown in FIG. 17A. The second biasing element, which is a torsion spring in this example but may be any other suitable biasing element, is operably connected to the second wing 2020 to bias the second wing 2020 to its home position (and therefore biases the second leg 2020l2 into contact with the second stop 2020s).

In this example embodiment, to load the container 200′ into a storage area, the vehicle positions the container 200′ beneath the storage area so the rack engagers of the container are horizontally aligned with the container supports of the storage rack. The vehicle then begins raising the container 200′. As this occurs, the engagement fingers 2010l1 and 2020l1 of the first and second wings 2010 and 2020 engage the container support (151b in this illustrated example). As shown in FIG. 17B, continued vertical movement of the container 200′ results in the rack engager forcing the wings to pivot away from their home positions. Eventually, the container 200′ is raised high enough so it disengages the wings, and the biasing elements force the wings to pivot back to their respective home positions. The vehicle then lowers the container 200′ until the rack engagers (and here, the engagement fingers) of the container engage the container supports of the storage rack and the container supports support the container. Unloading the container 200′ occurs as explained above with respect to the methods 1300 and 1500, depending on whether the container 200′ is the only container in the storage area.

In other embodiments, only the engagement fingers are pivotably mounted to the side walls, and the legs are fixedly attached to the sidewall or do not exist.

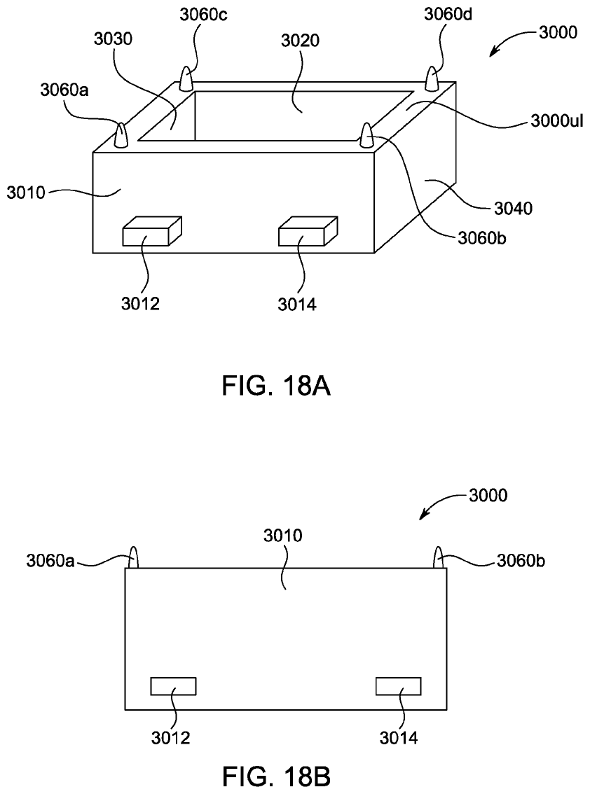

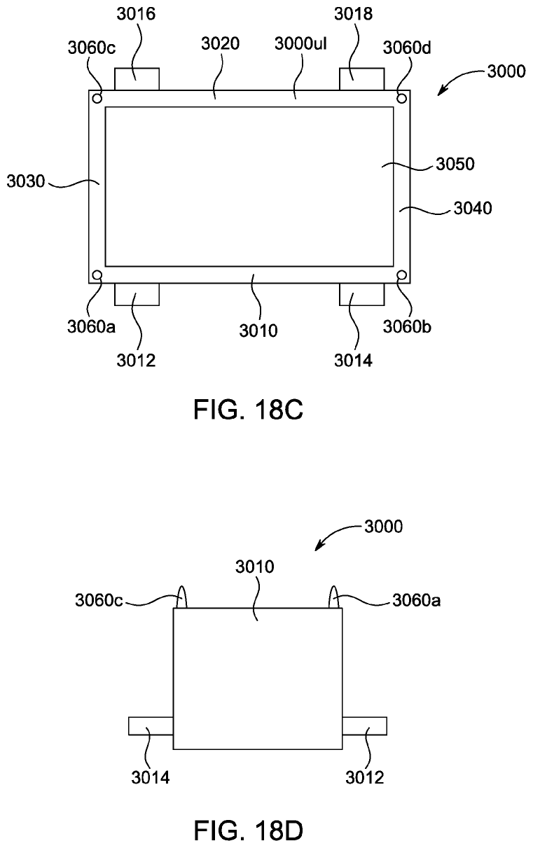

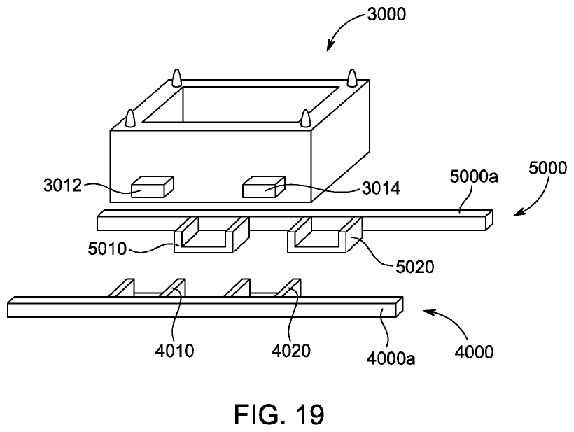

In the example embodiment described above with respect to FIGS. 1-16D, the container supports of the support rack and the rack engagers of the supports are sized, shaped, oriented, positioned, and otherwise configured so the container supports are received by the rack engagers when a container is loaded into a storage area. In other embodiments, on the other hand, the container supports and the rack engagers are sized, shaped, oriented, positioned, and otherwise configured so the rack engagers are received by the container supports when a container is loaded into a storage area. FIGS. 18A-19 show one such example embodiment.

FIGS. 18A-18D illustrate another example embodiment of the container 3000. The container 3000 includes a first side wall 3010; a second side wall 3020; a front wall 3030; a back wall 3040; a bottom wall 3050; first, second, third, and fourth rack engagers 3012, 3014, 3016, and 3018; and first, second, third, and fourth aligning members 3060a, 3060b, 3060c, and 3060d. The walls are connected to one another so the first and second side walls 3010 and 3020 are opposite one another; the front and back walls 3030 and 3040 are opposite one another, connect and extend between the first and second side walls 3010 and 3020, and are transverse to the first and second side walls 3010 and 3020; and the bottom wall 3050 is connected to the bottom edges of, extends between, and is transverse to the first and second side walls 3010 and 3020 and the front and back walls 3030 and 3040. The interior surfaces (not labeled) of these walls together define an item-storage area (not labeled) in which one or more items may be stored.

The upper edges of the walls 3010, 3020, 3030, and 3040 together form an upper lip 3000ul. The aligning members 3060a-3060d extend upwardly from respective corners of the upper lip 3000ul. In this example embodiment, the aligning members are integrally formed with the walls, though they may be attached separately in other embodiments. Additionally, in this example embodiment, the aligning members are conically shaped, though they may take any other suitable shape (such as a cylindrical shape) in other embodiments. Although not shown, portions of the lower edges of the walls 3010, 3020, 3030, and 3040 together form a lower lip. The walls and the lower lip define aligning-member-receiving openings sized, shaped, positioned, and otherwise configured to receive the aligning members of another container. Specifically, when a first container is stacked atop a second container, the aligning members of the second (lower) container are received by the aligning-member-receiving openings of the first (upper) container. This provides lateral support to prevent the first container from moving horizontally in the X- or Y-directions when stacked atop the second container. In certain embodiments in which the containers include aligning members and corresponding openings, the lift device includes similar aligning members to prevent movement of the containers in the X- and Y-directions when being transported by the vehicle. The aligning members are not limited for use with the container 3000 and may be used in connection with any suitable container design or configuration, such as the container 200 described above.

The rack engagers 3012, 3014, 3016, and 3018 are sized, shaped, positioned, oriented, and otherwise configured to engage the set of container supports of a given storage area of the storage rack when the container 3000 is loaded into and stored in that storage area. The first and second rack engagers 3012 and 3014 are connected to (and in this example embodiment, integrally formed with) the first side wall 3010, and the third and fourth rack engagers 3016 and 3018 are connected to (and in this example embodiment, integrally formed with) the second side wall 3020. In this example embodiment, each rack engager includes a body protruding from the appropriate side wall in the X-direction.

FIG. 19 shows two alternative dividers 4000 and 5000 including divider rails 4000a and 5000a having container supports 4010 and 4020 and 5010 and 5020, respectively, configured for engagement with the alternative rack engagers of the container 3000. In this example embodiment, to load the container 3000 into this storage area, the container 3000 is lowered such that the rack engagers 3012, 3014, 3016, and 3018 are lowered onto and received by the container supports 4010, 4020, 5010, and 5020. The container supports are U-shaped so their side walls prevent substantial movement of the container 3000 in the Y-direction once loaded.

While the AS/RS 10 shown in FIG. 1 is relatively small, the AS/RS may be scaled to fit any suitable physical space in a warehouse or other storage facility. For instance, multiple storage racks can be sized, shaped, and (if needed) secured together to fill the available floor space. If vertical space is available, the AS/RS can be configured as a multi-level system. For instance, FIG. 20 shows a two-level AS/RS with vehicles and storage racks on two levels. Although not shown, one or more lifts can be positioned adjacent the second level and controlled by the AS/RS control system C to transport vehicles between the floor level and the second level.

In the above-described examples, the vehicles 300 of the AS/RS 10 are independently and freely movable in both the X-and Y-directions. In other embodiments, the AS/RS includes rails to which the vehicles are mounted and along which the vehicles can move. In some of these embodiments, the rails to which the vehicles are mounted are supported by (such as suspended from) the storage rack.

In certain embodiments, the vehicle includes one or more weight sensors configured to sense the weight of an object-such as a container filled with items-on the lift device. These weight sensors can include load cells or any other suitable sensor(s). In certain such embodiments, the AS/RS control system uses feedback from the weight sensors to control movement of the vehicles. For instance, in certain embodiments, the AS/RS control system uses feedback from the weight sensors to confirm that a container was successfully loaded into or unloaded from a storage area. In other embodiments, the AS/RS control system uses feedback from the weight sensors to control the speed at which the vehicle and/or lift device moves. In other embodiments, the AS/RS control system confirms that the container is below a preset weight limit before loading the container into a storage area, and prevents that container from being stored in the storage area if its weight exceeds the weight limit.

Certain embodiments of the AS/RS system do not employ the methods 900 or 1500, instead employing the method 1100 for loading a container into a storage area and the method 1300 for unloading a container from a storage area regardless of whether one or more containers already occupies that particular storage area.

In certain embodiments, the container includes one or more fill-level sensors, such as an optical sensor, configured to sense the height of the items inside the item-storage area of the container. In certain such embodiments, the AS/RS control system uses feedback from the fill-level sensors to determine whether the items exceed a preset fill level, in which case the AS/RS system prevents that container from being stored in a storage area.

1. A method of storing a container in a storage rack, the method comprising:
moving the container to a position beneath a storage area of a storage rack;
moving the container until rack engagers of the container are above respective container supports of the storage rack; and
moving the container until the rack engagers of the container engage the respective container supports and the respective container supports support the container above a support surface.

2. The method of claim 1, wherein moving the container to the position beneath the storage area comprises moving the container to the position beneath the storage area so the rack engagers of the container are horizontally offset from the respective container supports of the storage rack.

3. The method of claim 1, wherein moving the container until the rack engagers of the container are above the respective container supports of the storage rack comprises moving the container vertically and horizontally until the rack engagers are above and horizontally aligned with the respective container supports.

4. The method of claim 3, wherein moving the container until the rack engagers of the container are above the respective container supports of the storage rack comprises moving the container vertically until the rack engagers are above the respective container supports and then moving the container horizontally until the rack engagers are horizontally aligned with the respective container supports.

5. The method of claim 3, wherein:
moving the container to the position beneath the storage area of the storage rack comprises controlling a vehicle supporting the container on a lift device to, with the lift device in a home position, move the container to the position beneath the storage area; moving the container vertically comprises controlling the vehicle to move the lift device vertically; and
moving the container horizontally comprises one of:
controlling the vehicle to move horizontally;
controlling the lift device to move horizontally relative to a chassis of the vehicle; and
activating a conveying device of the vehicle.

6. The method of claim 5, wherein moving the container until the rack engagers of the container engage the respective container supports of the storage rack comprises controlling the vehicle to lower the lift device.

7. An automated storage and retrieval system comprising:
a storage rack including multiple container supports and defining a storage area;
a vehicle including a chassis, one or more driven wheels, and a lift device vertically movable relative to the chassis from a home position;
a container including multiple walls and multiple rack engagers configured to engage the container supports of the storage rack; and
a controller communicatively connectable to the vehicle and configured to:
with the lift device of the vehicle supporting the container, control the vehicle to move the container to a position beneath the storage area of the storage rack;
control the vehicle to move the container until the rack engagers of the container are above the container supports; and
control the vehicle to move the container until the rack engagers of the container engage the respective container supports and the container supports support the container above a support surface.

8. The system of claim 7, wherein the controller is configured to control the vehicle to move the container to the position beneath the storage area of the storage rack by controlling the vehicle to drive the one or more driven wheels.

9. The system of claim 7, wherein the controller is configured to control the vehicle to move the container to the position beneath the storage area of the storage rack so the rack engagers of the container are horizontally offset from the respective container supports of the storage rack.

10. The system of claim 7, wherein the controller is configured to control the vehicle to move the container until the rack engagers of the container are above the respective container supports by controlling the vehicle to move the container vertically and horizontally until the rack engagers are above and horizontally aligned with the respective container supports.

11. The system of claim 10, wherein the controller is configured to control the vehicle to move the container until the rack engagers of the container are above the respective container supports by controlling the vehicle to move the container vertically until the rack engagers are above the respective container supports and then to move the container horizontally until the rack engagers are horizontally aligned with the respective container supports.

12. The system of claim 10, wherein the controller is configured to:
control the vehicle to move the container vertically by controlling the vehicle to move the lift device vertically; and
control the vehicle to move the container horizontally by one of:
controlling the vehicle to move horizontally;
controlling the vehicle to move the lift device horizontally relative to the chassis of the vehicle; and
activating a conveying device of the vehicle.

13. The system of claim 12, wherein the vehicle further comprises a lift actuator operably connected to the lift device to move the lift device vertically.

14. The system of claim 12, the controller is configured to control the vehicle to move the container until the rack engagers of the container engage the respective container supports by controlling the vehicle to lower the lift device.

15 to 84. (canceled)

85. An automated storage and retrieval system comprising:
a storage rack including multiple container supports and defining a storage area;
a vehicle including a chassis, one or more driven wheels, and a lift device vertically movable relative to the chassis from a home position;
a container including multiple walls and multiple rack engagers, each rack engager connected to one of the walls and including a pivotable engagement finger and a biasing element biasing the engagement finger to a home position; and
a controller communicatively connectable to the vehicle and configured to:
with the lift device of the vehicle supporting the container, control the vehicle to move the container to a position beneath the storage area of the storage rack so the rack engagers of the container are horizontally aligned with the respective container supports of the storage rack;
control the vehicle to raise the lift device so the engagement fingers of the rack engagers engage the respective container supports, are pivoted away from their home positions by the container supports, and are forced back to their home positions by the respective biasing elements and positioned above the container supports; and
control the vehicle to lower the lift device so the rack engagers of the container engage the respective container supports and the container supports support the container above a support surface.
